(19) United States
(12) Patent Application Publication
(10) Pub. No.: US 2014/0137193 A1
(43) Pub. Date: May 15, 2014

(54) COMMUNICATION SYSTEM, METHOD FOR PERFORMING THE SAME AND COMPUTER READABLE MEDIUM

(71) Applicant: Takeru INOUE, Kanagawa (JP)

(72) Inventor: Takeru INOUE, Kanagawa (JP)

(21) Appl. No.: 14/074,203

(22) Filed: Nov. 7, 2013

(30) Foreign Application Priority Data
Nov. 15, 2012 (JP) 2012-251681

(51) Int. Cl. H04N 7/15; H04L 29/06

(52) U.S. Cl. CPC H04N 7/15; H04L 63/08
USPC 726/3

(57) ABSTRACT

A communication system including: a first acquiring unit configured to obtain start request information for specifying whether participation in the session of a terminal is limited or not, and participation authentication information for authenticating participation in the session for the terminal; a session manager configured to establish the session; a second acquiring unit configured to obtain participation request information for requesting participation of a third terminal in the session, and the participation authentication information input from the third terminal; and a participation determination unit configured to compere the participation authentication obtained by the first acquiring unit and by the second acquiring unit, and determine whether participation of the third terminal in the session is allowed or not, and the participation determination unit configured to record terminal information of the third terminal, and to reject a subsequent participation request of the third terminal in the session thereafter.

### CROSS-REFERENCE TO RELATED APPLICATIONS

The present application claims priority to and incorporates by reference the entire contents of Japanese Patent Application No. 2012-251681 filed in Japan on Nov. 15, 2012.

### BACKGROUND OF THE INVENTION

1. Field of the Invention

The present invention relates to a communication system, a method for performing the communication system and a computer readable medium including a computer program product.

2. Description of the Related Art

With recent demands for reducing the costs and time for business trips, voice communication systems for carrying out TV conferences etc. via a communication network, such as the Internet, become common. In such a communication system, once voice communications are started between voice communication terminals, image data and audio data are transmitted/received, which enables a TV conference.

Furthermore, recent quality broadband environments allow transmitting/receiving of high-quality image and audio data between voice communication terminals. This makes it possible to easily understand the environment of the peers in the TV conference and thus improves communication satisfactions from conversations.

Some conferences involve transmitting/receiving of highly confidential data, and accordingly a technology for appropriately restricting members to join the conference is required to be provided. Such a technology for restricting members to join a conference is disclosed in Japanese Laid-open Patent Publication No. H7-177482 where, in order to restrict members to join a conference, members are registered before the conference starts and joining of members other than the registered members is restricted.

However, the technology disclosed in Japanese Laid-open Patent Publication No. H7-177482 requires the operation by the user to previously register members to join the conference. Thus, there is a demand for, with a more simple operation and appropriately, restricting members and allowing specific members to join the conference, thereby improving the security.

Therefore, there is a need to provide a communication system, a communication method, and a program for more easily and appropriately restricting terminals that can join communications and allowing only specific terminals to join the communications, thereby improving the security and consulting the convenience for the user.

### SUMMARY OF THE INVENTION

It is an object of the present invention to at least partially solve the problems in the conventional technology.

According to an aspect of the invention, a communication system is provided. The communication system includes: a first acquiring unit configured to obtain start request information for requesting start of a session between a first terminal and a second terminal and the start request information including information for specifying whether participation in the session of a terminal other than the first terminal and the second terminal is limited or not, and participation authentication information for authenticating participation in the session for the terminal when the participation of the terminal in the session is limited; a session manager configured to establish the session between the first terminal and the second terminal according to the start request information; a second acquiring unit configured to obtain participation request information for requesting participation of a third terminal in the session, and the participation authentication information input from the third terminal; and a participation determination unit configured to, when the participation request information consists of a participation request in the session in which the participation of the terminal is limited, compere the participation authentication obtained by the first acquiring unit and participation authentication information obtained by the second acquiring unit, and determine whether participation of the third terminal in the session is allowed or not according to a result of comparison, and the participation determination unit configured, if the participation of the third terminal in the session is not allowed, to record terminal information of the third terminal, and to reject a subsequent participation request of the third terminal in the session thereafter on the basis of the recorded terminal information.

According to another aspect of the invention, a method for performing a communication system is provided. The communication system includes: a first acquiring unit configured to obtain start request information for requesting start of a session between a first terminal and a second terminal and the start request information including information for specifying whether participation in the session of a terminal other than the first terminal and the second terminal is limited or not, and participation authentication information for authenticating participation in the session for the terminal when the participation of the terminal in the session is limited; a session manager configured to establish the session between the first terminal and the second terminal according to the start request information; a second acquiring unit configured to obtain participation request information for requesting participation of a third terminal in the session, and the participation authentication information input from the third terminal; and a participation determination unit configured to, when the participation request information consists of a participation request in the session in which the participation of the terminal is limited, compere the participation authentication obtained by the first acquiring unit and participation authentication information obtained by the second acquiring unit, and determine whether participation of the third terminal in the session is allowed or not according to a result of comparison, and the participation determination unit configured, if the participation of the third terminal in the session is not allowed, to record terminal information of the third terminal, and to reject a subsequent participation request of the third terminal in the session thereafter on the basis of the recorded terminal information. The method includes: obtaining start request information for requesting start of the session between the first terminal and the second terminal and the start request information including information for specifying whether participation in the session of a terminal other than the first terminal and the second terminal is limited or not, and the participation authentication information for authenticating participation in the session for the terminal when the participation of the terminal in the session is limited; establishing the session between the first terminal and the second terminal according to the start request information; obtaining the participation request information for requesting participation of the third terminal in the session, and the participation authentication information input from the third terminal; when the participation request information consists of the participation request in the session in which the participation of the terminal is limited, compering the participation authentication obtained by the first acquiring unit and the participation authentication information obtained by the second acquiring unit, and determining whether participation of the third terminal in the session is allowed or not according to the result of comparison, and if the participation of the third terminal in the session is not allowed, recording the terminal information of the third terminal, and rejecting the subsequent participation request of the third terminal in the session thereafter on the basis of the recorded terminal information.

According to further aspect of the invention, a computer readable medium including a computer program product, the computer program product comprising instructions which, when executed by a computer, causes the computer to perform operation of a communication system is provided. The communication system includes: a first acquiring unit configured to obtain start request information for requesting start of a session between a first terminal and a second terminal and the start request information including information for specifying whether participation in the session of a terminal other than the first terminal and the second terminal is limited or not, and participation authentication information for authenticating participation in the session for the terminal when the participation of the terminal in the session is limited; a session manager configured to establish the session between the first terminal and the second terminal according to the start request information; a second acquiring unit configured to obtain participation request information for requesting participation of a third terminal in the session, and the participation authentication information input from the third terminal; and a participation determination unit configured to, when the participation request information consists of a participation request in the session in which the participation of the terminal is limited, compere the participation authentication obtained by the first acquiring unit and participation authentication information obtained by the second acquiring unit, and determine whether participation of the third terminal in the session is allowed or not according to a result of comparison, and the participation determination unit configured, if the participation of the third terminal in the session is not allowed, to record terminal information of the third terminal, and to reject a subsequent participation request of the third terminal in the session thereafter on the basis of the recorded terminal information. The operation includes: obtaining start request information for requesting start of the session between the first terminal and the second terminal and the start request information including information for specifying whether participation in the session of a terminal other than the first terminal and the second terminal is limited or not, and the participation authentication information for authenticating participation in the session for the terminal when the participation of the terminal in the session is limited; establishing the session between the first terminal and the second terminal according to the start request information; obtaining the participation request information for requesting participation of the third terminal in the session, and the participation authentication information input from the third terminal; when the participation request information consists of the participation request in the session in which the participation of the terminal is limited, compering the participation authentication obtained by the first acquiring unit and the participation authentication information obtained by the second acquiring unit, and determining whether participation of the third terminal in the session is allowed or not according to the result of comparison, and if the participation of the third terminal in the session is not allowed, recording the terminal information of the third terminal, and rejecting the subsequent participation request of the third terminal in the session thereafter on the basis of the recorded terminal information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a transfer system according to a first embodiment;

FIG. 2 is a hardware configuration diagram of a transfer terminal according to the first embodiment;

FIG. 3 is a hardware configuration diagram of a transfer management system, a relay device, a program providing system, or a maintenance system according to the first embodiment;

FIG. 4 is a functional block diagram of each terminal, each device, and each system that constitute the transfer system according to the first embodiment;

FIG. 5 is a schematic diagram of a relay device management table according to the first embodiment;

FIG. 6 is a schematic diagram of a terminal authentication management table according to the first embodiment;

FIG. 7 is a schematic diagram of a terminal management table according to the first embodiment;

FIG. 8 is a schematic diagram of a destination list management table according to the first embodiment;

FIG. 9 is a schematic diagram of a session management table according to the first embodiment;

FIG. 10 is a schematic diagram of a state change management table according to the first embodiment;

FIG. 11 is a schematic diagram of a state change management table according to the first embodiment;

FIG. 12 is a state transition diagram of the communication state;

FIG. 13 is a state transition diagram of the communication state;

FIG. 14 is a sequence chart of a process for managing state information that indicates the operation state of each relay device;

FIG. 15 is a schematic diagram of the state where contents data and various types of management information are transmitted/received in the transfer system;

FIG. 16 is a sequence chart of a preparatory process for starting voice communications between transfer terminals;

FIG. 17 is a diagram of an example of display of a destination list;

FIG. 18 is a sequence chart of a process for requesting to start communications;

FIG. 19 is a flowchart of a detailed procedure performed by a start requesting terminal in a destination selecting process;

FIG. 20 is a diagram of an example of display of an outgoing call checking dialogue;

FIG. 21 is a diagram of an example of display of a joining authentication information entering screen;

FIG. 22 is a flowchart of a procedure for changing the communication state;

FIG. 23 is a sequence chart of a process for accepting the request to start communications;

FIG. 24 is a diagram of an example of display of a start request accepting screen;

FIG. 25 is a sequence chart of a process for making a request to relay contents data;

FIG. 26 is a flowchart of a procedure for changing the communication state;

FIG. 27 is a sequence chart of a process for transmitting information of a request to join a contents data session;

FIG. 28 is a diagram of an example of display of a destination list;

FIG. 29 is a flowchart of a procedure for joining determination based on the communication state;

FIG. 30 is a diagram of an example of a joining authentication information re-entering screen;

FIG. 31 is a diagram of an example of display of a message on the display of a terminal that is joining a session;

FIG. 32 is a flowchart of a procedure for changing the communication state;

FIG. 33 is a diagram of an example of a terminal management table according to a second embodiment;

FIG. 34 is a flowchart of a procedure for joining determination according to the second embodiment;

FIG. 35 is a sequence chart of a process for transmitting information of a request to join a contents data session according to the second embodiment;

FIG. 36 is a diagram of an example of a joining rejection notice that is displayed on the display of a joining requesting terminal; and

FIG. 37 is a schematic diagram of a destination list according to another embodiment.

### DETAILED DESCRIPTION OF THE PREFERRED EMBODIMENTS

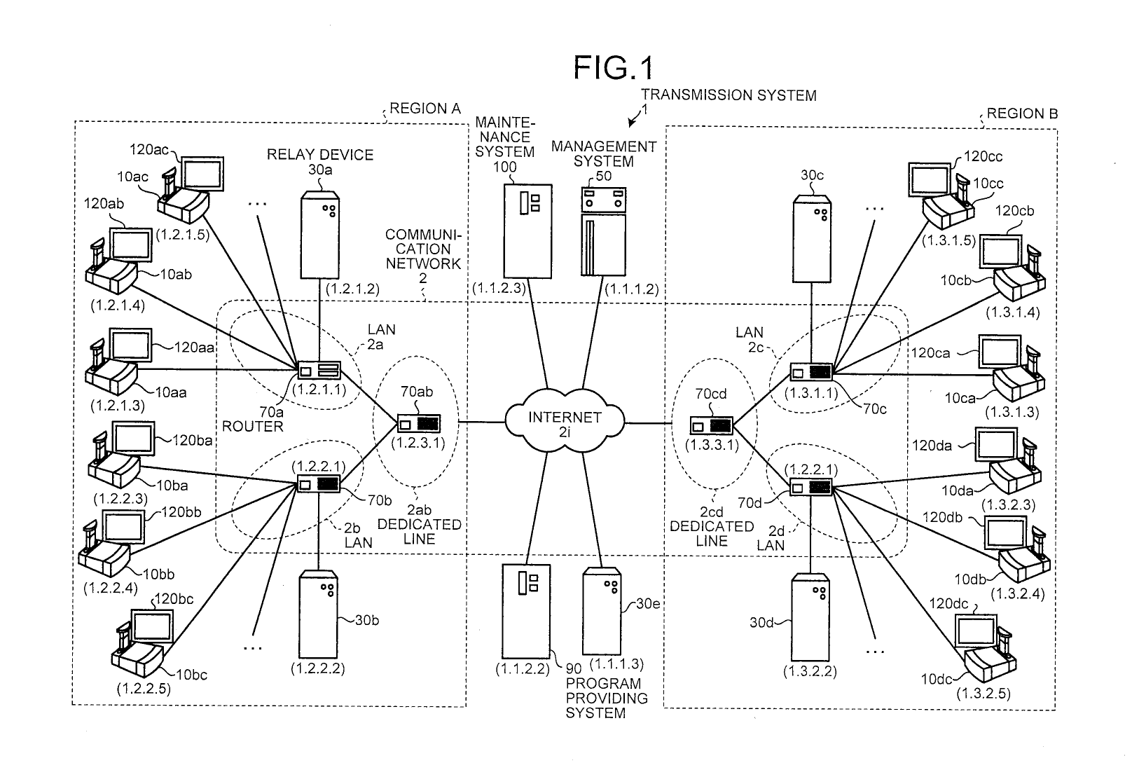

Embodiments of a communication system, a communication method, and a program will be described in detail below with reference to the accompanying drawings. FIG. 1 is a block diagram of a communication system and a program configuration according to an embodiment.

### First Embodiment

### Entire Configuration of Embodiment

An embodiment of a communication system and a program will be described in detail below with reference to FIGS. 1 to 32. FIG. 1 is a schematic diagram of a transfer system 1 according to a first embodiment that serves as a communication system. First, the embodiment will be described schematically with reference to FIG. 1.

The transfer system 1 includes a data providing system that permits one-way transfer of contents data from one transfer terminal to another transfer terminal via a transfer management system; and a communication system that allows bi-directional communications of information, feelings, etc. between transfer terminals via the transfer management system. The communication system is used to bi-directionally communicate information, feelings, etc. between communication terminals (corresponding to “transfer terminals”) via a communication management system (corresponding to “transfer management system”). Examples of the system include a TV conference system, a videophone system, an audio conference system, an audio phone system, and a PC (personal computer) screen sharing system.

In the first embodiment, a TV conference system that is an example of the communication system, a TV conference management system that is an example of the communication management system, and a TV conference terminal that is an example of the communication terminal are assumed, and the transfer system 1, a transfer management system 50, and a transfer terminal 10 will be described below. Specifically, the communication system of the first embodiment can be applied not only to TV conference systems but also to communication systems or transfer systems.

The transfer system 1 shown in FIG. 1 includes transfer terminals (10aa, 10ab, . . . ), displays (120aa, 120ab, . . . ) for each of the transfer terminals (10aa, relay devices (30a, 30b, 30c, 30d and 30e), the transfer management system 50, a program providing system 90, and a maintenance system 100. Hereinafter, “transfer terminal” is simply referred to as “terminal” and “transfer management system” is simply referred to as “management system”.

In the first embodiment, “transfer terminal 10” is used to indicate an arbitrary transfer terminal among the transfer terminals (10aa, 10ab, . . . ) and “display 120” is used to indicate an arbitrary display among the displays (120aa, 120ab, . . . ), and “relay device 30” is used to indicate an arbitrary relay device among the relay devices (30a, 30b, 30c, 30d and 30e).

A terminal 10 transmits and receives various types of information with another device. The terminal 10 establishes a session with another terminal 10 and carries out voice communications by transmitting/receiving contents data including audio data and image data over the established session. Accordingly, a TV conference between terminals 10 can be carried out in the transfer system 1.

Hereinafter, “image data and audio data” are referred to as “contents data”. The data that is transferred between the terminals 10 is not limited to the data of the first embodiment. Alternatively, the contents data may be text data. Alternatively, the contents data may contain text data in addition to audio data and image data. The image data may be video images or still images. The image data may contain both of video images and still images.

In the transfer system 1 according to the first embodiment, when a TV conference is started, a user who wants to start the TV conference operates a given terminal 10 so that the operated terminal 10 transmits a start request information to the management system 50.

The start request information is for requesting to start a session that is used for the TV conference and contains information that specifies a terminal 10 as a session peer. Hereinafter, the terminal 10 that transmits the start request information is referred to as a start requesting terminal and the terminal 10 that is specified as a session peer is referred to as a destination terminal.

One or more terminals 10 may serve as destination terminal(s) (session peer(s)). In other words, the transfer system 1 carries out a TV conference using a session that is established between not only two terminals 10 but three or more terminals 10.

Furthermore, in the transfer system 1 according to the first embodiment, another user can join a TV conference that has been already started by establishing a session. A user who wants to join the session operates a given terminal 10 in order to transmit, to the management system 50, joining request information that specifies the session that has been established (hereinafter, “running session”) and that is used for the TV conference in which the user wants to join. Hereinafter, the terminal 10 that transmits the joining request information is referred to as a joining requesting terminal.

The management system 50 unitarily manages terminals 10 and relay devices 30. The management system 50 establishes a session between terminals 10 to carry out a videoconference between the terminals 10 by voice communications etc.

Upon receiving information of a request to start a session from a given terminal 10, the management system 50 establishes a session between the terminal that has transmitted the start request information (the start requesting terminal) and a destination terminal in order to start a TV conference. Furthermore, upon receiving information of a request to join a session that has been established (running session) from a given terminal 10, the management system 50 determines whether to allow the joining requesting terminal to join the running session.

Routers (70a, 70b, 70c, 70d, 70ab and 70cb) shown in FIG. 1 select the best route for contents data. In the first embodiment, “router 70” is used to indicate an arbitrary router among the routers (70a, 70b, 70c, 70d, 70ab and 70cb). A relay device 30 relays contents data between terminals 10.

The program providing system 90 includes an HD (Hard Disk) (not shown) that stores a terminal program for allowing a terminal 10 to enable various functions and means. The program providing system 90 can transmit the terminal program. The HD of the program providing system 90 also stores a relay device program for allowing a relay device 30 to enable various functions and means. The program providing system 90 can transmit the relay device program to a relay device 30. Furthermore, the HD of the program providing system 90 stores a transfer management program for allowing the management system 50 to enable various functions and means. The program providing system 90 can transmit the transfer management program to the management system 50.

The maintenance system 100 is a computer that performs maintenance or management of at least one of terminals 10, relay devices 30, the management system 50, and the program providing system 90. For example, if the maintenance system 100 is installed in the country and a terminal 10, a relay device 30, the management system 50 or the program providing system 90 is installed abroad, the maintenance system 100 remotely performs maintenance including upkeep and control of at least one of the terminal 10, the relay device 30, the management system 50 and the program providing system 90 via a communication network 2. Furthermore, the maintenance system 100 performs, not via the communication network 2, maintenance including management of the product number, serial number, customer, maintenance check and failure history of at least one of the terminal 10, the relay device 30, the management system 50 and the program providing system 90.

The terminals (10aa, 10ab, 10ac, 10a . . . ), the relay device 30a, and the router 70a are communicably connected via a LAN 2a. Terminals (10ba, 10bb, 10bc, 10b . . . ), the relay device 30b, and the router 70b are communicably connected via a LAN 2b. The LAN 2a and the LAN 2b are communicably connected via a dedicated line tab that includes the router 70ab and are developed in a given region A. For example, the region A is Japan and the LAN 2a is developed in an office in Tokyo and the LAN 2b is developed in an office in Osaka.

The terminals (10ca, 10cb, 10cc, 10c . . . ), the relay device 30c, and the router 70c are communicably connected via a LAN 2c. The terminals (10da, 10db, 10dc, 10d . . . ), the relay device 30d, and the router 70d are communicably connected via a LAN 2d. The LAN 2c and the LAN 2d are communicably connected via a dedicated line 2cd and are developed in a given region B. For example, the region B is the United States and the LAN 2c is developed in an office in New York and the LAN 2d is developed in an office in Washington D.C. The region A and the region B are communicably connected via the routers (70ab, 70cd) and the Internet 2i.

The management system 50 and the program providing system 90 are communicably connected to the terminals 10 and the relay devices 30 via the Internet 2i. The management system 50 and the program providing system 90 may be installed in the region A, the region B or another region.

The relay device 30e is communicably connected to the terminals 10 via the communication network 2. The relay device 30e runs all the time and is installed outside the region A and the region B in order to be insulated from the influence of communications in the local area of the region A and the region B. Thus, when a terminal 10 makes voice communications with a terminal that is installed in another local area, the relay device 30e is used as a relay device for relaying contents data. When terminals in the same local region make voice communications but the relay device installed in the local area does not run, the relay device 30e is used as an emergency relay device.

In the first embodiment, the LAN 2a, the LAN 2b, the dedicated line 2ab, the Internet 2i, the dedicated line 2cd, the LAN 2c, and the LAN 2d develop the communication network 2 of the first embodiment. The communication network 2 may have a part where wireless communications are performed in addition to wired communications.

The set of four numbers shown under each terminal 10, each relay device 30, the management system 50, each router 70, the program providing system 90, and the maintenance system 100 shown in FIG. 1 indicates a normal IP addresses in IPv4 in a simplified manner. For example, the IP address of the terminal 10aa is “1.2.1.3”. IPv6 may be used instead of IPv4. But IPv4 is used to simplify its description.

Hardware Configuration of the First Embodiment

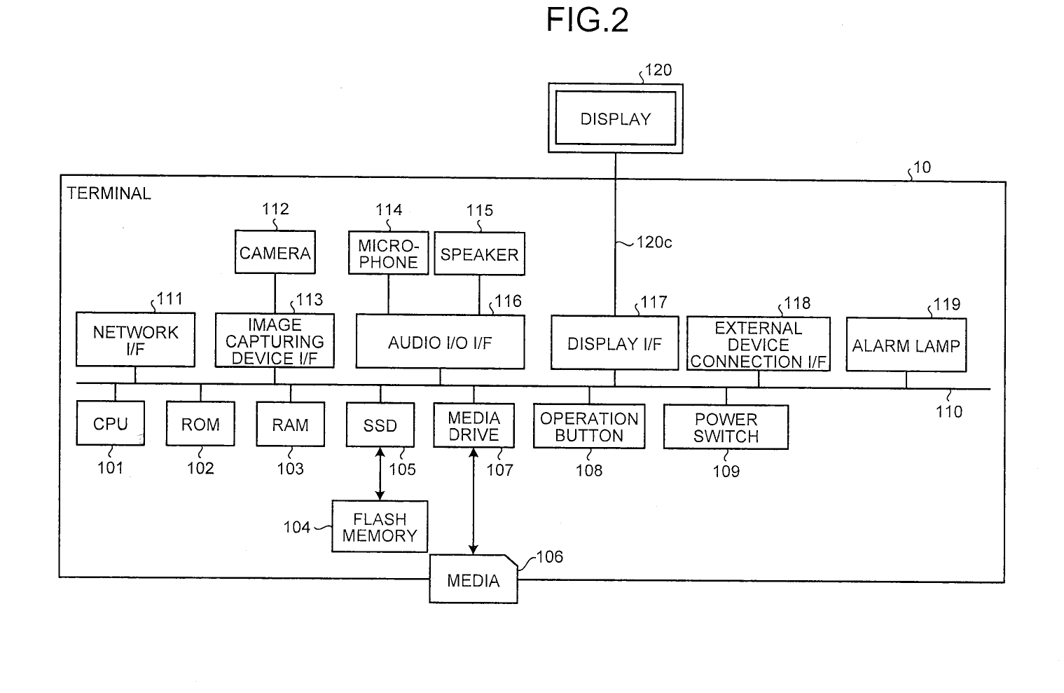

A hardware configuration of the first embodiment will be described below. FIG. 2 is a hardware configuration diagram of a terminal 10 according to the first embodiment. As shown in FIG. 2, the terminal 10 according to the first embodiment includes a CPU (Central Processing Unit) 101 that controls overall operations of the terminal 10; a ROM (Read Only Memory) 102 that stores the terminal program; a RAM (Random Access Memory) 103 that is used as a work area for the CPU 101; a flash memory 104 that stores various types of data, such as image data and audio data; an SSD (Solid State Drive) 105 that control reading/writing of various types of data from/in the flash memory 104 according to the control of the CPU 101; a media drive 107 that controls reading/writing of data from/in a recording medium 106, such as a flash memory; an operation button 108 that is operated to, for example, select a destination of the terminal 10; a power switch 109 for turning on/off the power of the terminal 10; and a network I/F (Interface) 111 for transferring data by using the communication network 2. The SSD 105 may be an HDD (Hard Disk Drive).

The terminal 10 further includes a built-in camera 112 that acquires image data by imaging an object according to the control of the CPU 101; an imaging device I/F 113 that controls driving of the camera 112; a built-in microphone 114 for inputting audio; a built-in speaker 115 for outputting audio; an audio I/O I/F 116 that processes input/output of audio signals between the microphone 114 and the speaker 115 according to the control of the CPU 101; a display I/F 117 that transfers image data to an external display 120 according to the control of the CPU 101; an external device connection I/F 118 for connecting various external devices; an alarm lamp 119 that warns an abnormality in various functions of the terminal 10; and a bus line 110, such as an address bus or a data bus, for electrically connecting the above-listed components as shown in FIG. 2.

The display 120 is a liquid crystal or organic EL display unit on which images of an object or operation icons are displayed. The display 120 is connected to the display I/F 117 via a cable 120c. The cable 120c may be an analog RGB (VGA) signal cable, a component video cable, or a HDMI (High-Definition Multimedia Interface) or DVI (Digital Video Interactive) signal cable.

The camera 112 includes a lens and a solid-state imaging device that converts light to electric charges to digitize images (video images) of the object. For the solid-state imaging device, a CMOS (Complementary Metal Oxide Semiconductor), a CCD (Charge Coupled Device), etc. are used.

External devices, such as an external camera, an external microphone, and an external speaker, are electrically connectable to the external device connection I/F 118 by using an USB (Universal Serial Bus) cable. When the external camera is connected, it operates prior to the internal camera 112 according to the control of the CPU 101. Similarly, when the external microphone or the external speaker is connected, the external microphone or the external speaker operates prior to the built-in microphone 114 or the built-in speaker 115 according to the control of the CPU 101. The terminal 10 may be a general-purpose PC (Personal Computer), a smart phone, a tablet terminal, or a mobile phone. The camera 112 or the microphone 114 is not necessarily built-in, and they may be external devices.

The recording medium 106 is removable the terminal 10. A non-volatile memory, such as an EEPROM (Electrically Erasable and Programmable ROM), from/to which data is read/written according to the control of the CPU 101 may be used instead of the flash memory 104.

The terminal program may be recorded and distributed in a computer-readable recording medium (such as the recording medium 106) in an installable and executable file. The terminal program may be stored not in the flash memory 104 but in the ROM 102.

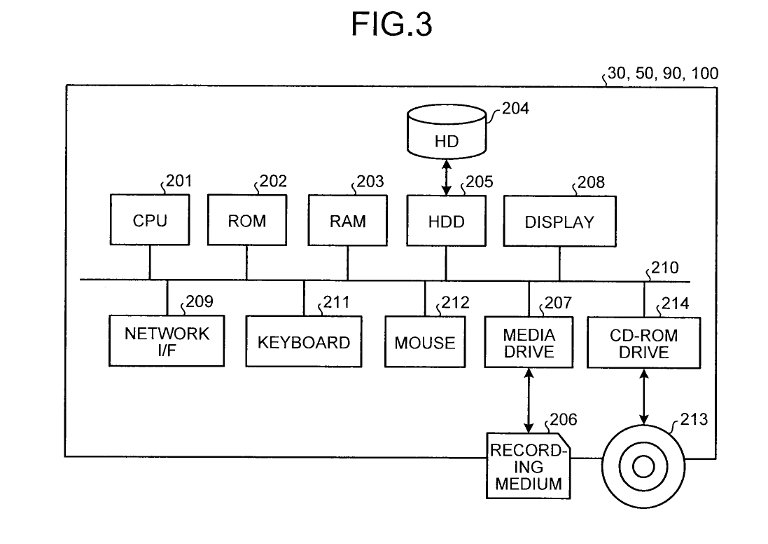

FIG. 3 is a hardware configuration diagram of the management system according to the first embodiment. The management system 50 includes a CPU 201 that controls overall operations of the management system 50; a ROM 202 that stores the transfer management program; a RAM 203 that is used as a work area for the CPU 201; an HD (Hard Disk) 204 that stores various types of data; an HDD 205 that controls reading/writing of various types of data from/in the HD 204; a media drive 207 that controls reading/writing (memory) from/in the recording media 206, such as a flash memory; a display 208 that displays various types of information, such as a cursor, a menu, a window, letters, and images; a network I/F 209 for transferring data by using the communication network 2; a keyboard 211 that includes keys for entering letters, numerals, various instructions, etc.; a mouse 212 for selecting and executing various instructions, selecting an object to be processed, and moving the cursor; a CD-ROM drive 214 that controls reading/writing of data from/in a CD-ROM (Compact Disc Read Only Memory) 213 that is an example of the removable recording medium; and a bus line 210, such as an address bus or a data bus, for electrically connecting the above-listed components as shown in FIG. 3.

The transfer management program may be recorded and distributed in an installable and executable file and in a computer-readable recording medium, such as the recording medium 206 and the CD-ROM 213.

A relay device 30 has the same hardware configuration as that of the management system 50 and thus descriptions thereof will be omitted below. However, the relay device program for controlling the relay device 30 is recorded in the ROM 202. The relay device program may be recorded and distributed in an installable and executable file and in a computer-readable recording medium, such as the recording medium 206 or the CD-ROM 213.

The program providing system 90 has the same hardware configuration as that of the management system 50 and thus descriptions thereof will be omitted below. However, a program provision program for controlling the program providing system 90 is recorded in the ROM 202. The program provision program may be recorded and distributed in an installable and executable file and in a computer-readable recording medium, such as the recording medium 206 or the CD-ROM 213.

The maintenance system 100 has the same hardware configuration as that of the management system 50 and thus descriptions thereof will be omitted below. However, a maintenance program for controlling the maintenance system 100 is recorded in the ROM 202. The maintenance program may be recorded and distributed in an installable and executable file and in a computer-readable recording medium, such as the recording medium 206 or the CD-ROM 213.

Regarding other examples of the removable recording medium, the program may be recorded and provided in a computer-readable recording medium, such a CD-R (Compact Disc Recordable), a DVD (Digital Versatile Disk), or a Blue-ray disc.

Functional Configurations of the First Embodiment

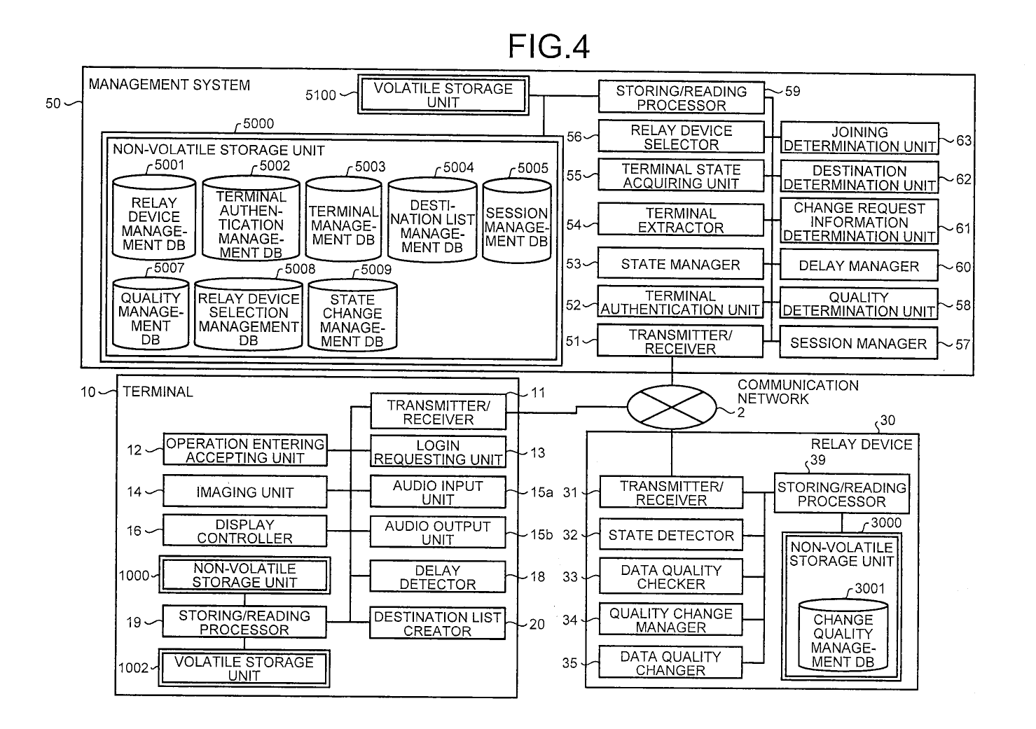

Here, a functional configuration of the first embodiment will be described. FIG. 4 is a functional block diagram of the functional configuration of each terminal, each device, and each system that constitute the transfer system 1 according to the first embodiment. As shown in FIG. 4, a terminal 10, a relay device 30 and the management system 50 are connected via the communication network 2 such that data communications are enabled. Because the program providing system 90 and the maintenance system 100 shown in FIG. 1 do not directly concern the communications in a TV conference, they are omitted from FIG. 4.

Functional Configuration of Terminal

The terminal 10 includes a transmitter/receiver 11, an operational-entering accepting unit 12, a login requesting unit 13, an imaging unit 14, an audio input unit 15a, an audio output unit 15b, a display controller 16, a delay detector 18, a storing/reading processor 19, and a destination list creator 20. Each of these units is a function or means that is enabled by causing any one of the components shown in FIG. 3 to operate according to an instruction from the CPU 101 according to the program that is stored in the ROM 102. The terminal 10 includes a volatile storage unit 1002 that is developed by the RAM 103 shown in FIG. 2; and a non-volatile storage unit 1000 that is developed by the flash memory 104 shown in FIG. 2.

Each Functional Unit of Terminal

Each unit of a terminal will be described in detail below. The transmitter/receiver 11 of the terminal 10 is enabled by the network I/F 111 shown in FIG. 2. The transmitter/receiver 11 transmits/receives various types of data (or information) to/from other terminals, devices, or systems via the communication network 2.

The transmitter/receiver 11 establishes a session between the terminal 10 and another terminal 10 and, before a TV conference via voice communications is started, starts receiving, from the management system 50, state information that indicates the state of each terminal 10 that serves as a destination terminal candidate.

A destination terminal candidate is a peer with which the terminal 10 carries out a videoconference, i.e., a terminal 10 that can be specified as a session peer. In other words, the terminal 10 cannot establish a session with and cannot carry out a TV conference with a terminal that is not pre-set as a destination terminal candidate. The destination terminal candidate is a candidate of a peer terminal in a videoconference, i.e., a peer terminal candidate.

The state information indicates the operation state of each terminal 10 (whether it is On-line or Off-line) and the detailed state (hereinafter, communication state), e.g., whether, if it is On-line, the terminal is making voice communications or in a standby state. The state information indicates, in addition to the operation state and the communication state of each terminal 10, various states, for example, that the cable comes off from the terminal 10, that audio can be output but images cannot be output, or that setting is made such that audio is not output (MUTE). An exemplary case will be described below that the state information indicates the operation state and the communication state.

When the terminal 10 operates as a start requesting terminal, the transmitter/receiver 11 transmits start request information to the management system 50. The start request information is for requesting to start a session that is used for a TV conference. Specifically, the start request information contains information indicating a request to start a session, the terminal ID of the start requesting terminal that transmits the start request information, the terminal ID that identifies a destination terminal that will serves as a session peer, and restriction information indicating whether there is a restriction, for a terminal other than the destination terminal, on joining the session. The terminal ID is information for identifying the terminal 10 or the user of the terminal 10. The terminal ID may be previously stored in the terminal 10 or may be directly entered in the terminal 10 by the user.

Specifically, the start request information contains “Invite” or “Private Invite”. Here, “Invite” is information indicating a request to start a session and is restriction information indicating that there is no restriction on joining. In contrast, “Private Invite” is information indicating a request to start a session and is restriction information indicating that there is a joining restriction.

The restriction information will be described in detail. In the transfer system 1 according to the first embodiment, another terminal 10 can join a session that has been already established. However, there are conferences where it is preferable that another terminal be not permitted, for example, highly confidential conferences. In the transfer system 1 according to the first embodiment, joining of another terminal 10 to a running session is restricted depending on whether there is a joining restriction that is indicated by the restriction information.

When the terminal 10 operates as a joining requesting terminal, the transmitter/receiver 11 transmits joining request information to the management system 50. The joining request information is for requesting to join a running session that is being used for a TV conference that has been already started. Specifically, the joining request information contains information “Call” indicating that it is joining request information; the terminal ID of a joining requesting terminal that transmits the joining request information; and the terminal ID of the joining terminal that is joining the running session in which the joining requesting terminal wants to join. Specifically, the joining terminal is the start requesting terminal or the destination terminal that is indicated by the start request information that was transmitted to start the running session. The transmitter/receiver 11 functions as a start request information acquiring unit that acquires the start request information and a joining request information acquiring unit that acquires the joining request information.

The operational-entering accepting unit 12 is enabled by the operation button 108 and the power switch 109 and accepts various types of entering by the user. For example, when the user turns on the power switch 109, the operational-entering accepting unit 12 shown in FIG. 4 accepts the power-on and turns the power on.

Upon acceptance of the power-on that is enabled by the instruction from the CPU 101 shown in FIG. 2, the login requesting unit 13 automatically transmits login request information indicating a request to log in and the current IP address of the terminal 10 to the management system 50 from the transmitter/receiver 11 via the communication network 2. When the user turns off the power switch 109 from the on state, the transmitter/receiver 11 transmits the state information indicating that the power is to be turned off to the management system 50 and then the operational-entering accepting unit 12 turns off the power. Accordingly, the management system 50 can know that the terminal 10 is turned off from the on state.

The imaging unit 14 is enabled by an instruction from the CPU 101 shown in FIG. 2, the camera 112 and the imaging device I/F 113 that are shown in FIG. 2. The imaging unit 14 images an object and outputs the image data that is acquired by the imaging. The audio input unit 15a is enabled by the audio I/O I/F 116 shown in FIG. 2. After the voice of the user is converted to audio signals via the microphone 114, the audio input unit 15a inputs the audio data according to the audio signals. The audio signal output unit 15b is enabled by instructions from the CPU 101 shown in FIG. 2 and the audio I/O I/F 116 shown in FIG. 2. The audio signal output unit 15b outputs the audio signals according to the audio data to the speaker 115 and the speaker 115 outputs the audio.

The display controller 16 is enabled by the display I/F 117 shown in FIG. 2 and controls transmission of image data to the external display 120. Before the requesting terminal starts voice communications in a videoconference with a terminal 10 that is a desired destination, the display controller 16 causes the display 120 to display a destination list that contains each destination name reflecting the state information, which is received after the transmitter/receiver 11 starts the receiving.

The delay detector 18 is enabled by an instruction from the CPU 101 shown in FIG. 2. The delay detector 18 detects a delay (ms) of image data or audio data that is transmitted from another terminal 10 via the relay device 30.

The storing/reading processor 19 is enabled by an instruction from the CPU 101 shown in FIG. 2 and, for example, by the SSD 105 shown in FIG. 2. The storing/reading processor 19 stores various types of data in the non-volatile storage unit 1000 and performs a process for reading various types of data stored in the non-volatile storage unit 1000. The non-volatile storage unit 1000 stores the terminal ID (Identification) for identifying the terminal 10, the password etc. Furthermore, the storing/reading processor 19 stores/reads various types of data in/from the volatile storage unit 1002. Contents data that is received when voice communications are made with the destination terminal is overwritten and stored in the volatile storage unit 1002 every time it is received. An image is displayed on the display 120 by using the image data before being overwritten and audio is output from the speaker 115 by using the audio data before being overwritten.

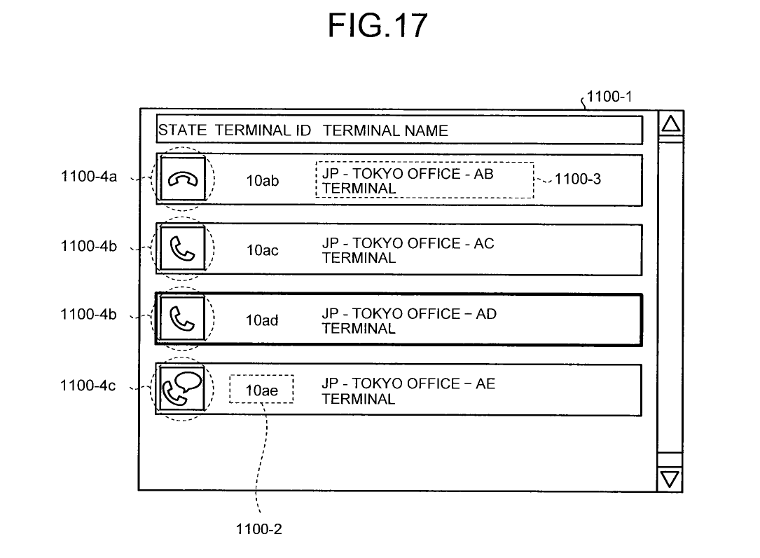

The destination list creator 20 creates and updates the destination list, like that shown in FIG. 17, in which the states of destination candidates are shown by icons on the basis of the destination list information and the state information on terminals 10, each serving as a destination candidate, that are received from the management system 50.

(Functional Configuration of Relay Device)

The functions and means of the relay device 30 will be described. The relay device 30 includes a transmitter/receiver 31, a state detector 32, a data quality checker 33, a quality change manager 34, a data quality changer 35, and a storing/reading processor 39. Each of these units is a function or means that is enabled by causing any one of the components shown in FIG. 3 to run according to an instruction from the CPU 201 according to the program that is stored in the ROM 202. The relay device 30 is developed by the HD 204 shown in FIG. 3 and includes a non-volatile storage unit 3000 that keeps the memory of various types of data and information even when the relay device 30 is powered off.

Quality Change Management Table

In the non-volatile storage unit 3000, a quality change management DB (Data Base) 3001 that consists of a quality change management table is developed. In the quality change management table, the IP address of a terminal 10 to which image data is relayed by the relay device 30 and the image quality of the image data are managed in association with each other.

In the first embodiment, there are low-resolution images each serving as a base image consisting of horizontal 160 pixels and vertical 120 pixels; medium-resolution images each consisting of horizontal 320 pixels and vertical 240 pixels; and high-resolution images each consisting of horizontal 640 pixels and vertical 480 pixels. When a narrow-band path is used, low-quality image data consisting of only low-resolution image data serving as a base image is relayed. When a relatively wide band is used, low-resolution image data serving as a base image and medium-quality image data consisting of medium-resolution image data are relayed. When a very wide band is used, low-resolution image data serving as a base image, medium-resolution image data consisting of middle-resolution image data, and high-quality image data consisting of high-resolution image data is relayed.

<Each Functional Unit of Relay Device>

The configuration of each function of the relay device 30 will be described in detail below. Descriptions will be provided for each unit of the relay device 30 as well as the relationship between each unit of the relay device 30 and the main components among the components shown in FIG. 3 for enabling each unit of the relay device 30.

The transmitter/receiver 31 of the relay device 30 is enabled by using the network I/F 209 shown in FIG. 3 and transmits/receives various types of data (or information) to/from another terminal, device, or system via the communication network 2. The state detector 32 is enabled by an instruction from the CPU 201 shown in FIG. 3 and detects the operation state of the relay device 30 that includes the state detector 32. The operation state is indicated as “On-line”, “Off-line”, or “Failure”.

The data quality checker 33 is enabled by an instruction from the CPU 201 shown in FIG. 3. The data quality checker 33 checks the image quality of image data to be relayed, by searching the quality change management table with the IP address of the destination terminal serving as a search key and by extracting the image quality of the image data to be relayed. The quality change manager 34 is enabled by an instruction from the CPU 201 shown in FIG. 3. The quality change manager 34 changes the contents of the quality change management table of the quality change management DB 3001 on the basis of the quality information that is transmitted from the management system 50.

The data quality changer 35 is enabled by an instruction from the CPU 201 shown in FIG. 3. The data quality changer 35 changes the quality of image data that is transmitted from a terminal 10 on the basis of the changed contents of the quality change management table of the quality change management DB 3001. The storing/reading processor 39 is enabled by using the HDD 205 shown in FIG. 3. The storing/reading processor 39 performs processes for storing various types of data in the non-volatile storage unit 3000 and reading various types of data stored in the non-volatile storage unit 3000.

Functional Configuration of Management System

The functions and means of the management system 50 will be described. The management system 50 includes a transmitter/receiver 51, a terminal authentication unit 52, a state manager 53, a terminal extractor 54, a terminal state acquiring unit 55, a relay device selector 56, a session manager 57, a quality determination unit 58, a storing/reading processor 59, a delay manager 60, a change request information determination unit 61, a destination determination unit 62, and a joining determination unit 63. Each of these units is a function or means that is enabled by causing any one of the components shown in FIG. 3 to run according to an instruction from the CPU 201 according to the program that is stored in the ROM 202. The management system 50 is developed by the HD 204 shown in FIG. 3 and includes a non-volatile storage unit 5000 that keeps the memory of various types of data and information even when the management system 50 is powered off. Various types of information are stored in the non-volatile storage unit 5000. The management system 50 further includes a volatile storage unit 5100 that is developed by the RAM 203 shown in FIG. 3.

Relay Device Management Table

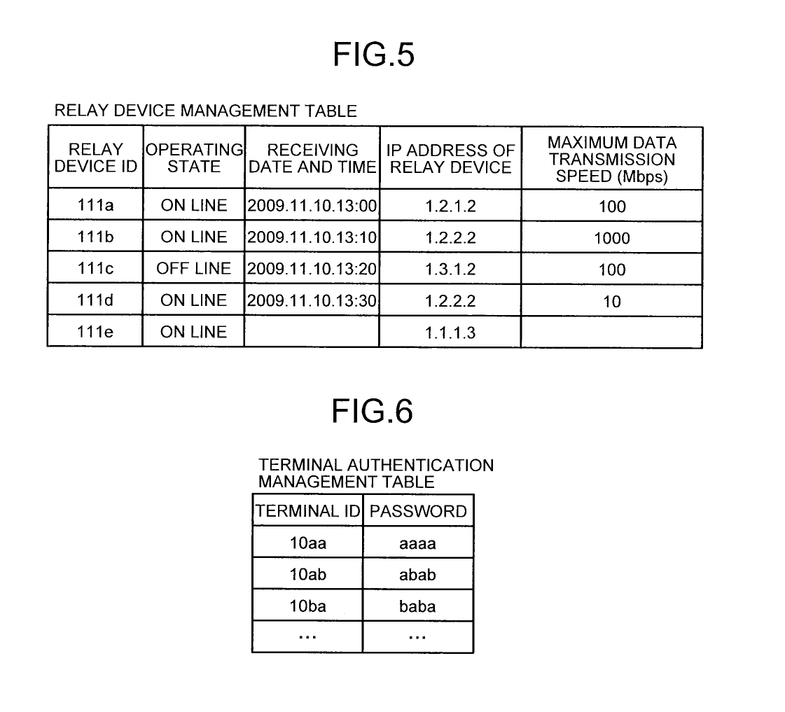

In the non-volatile storage unit 5000, a relay device management DB 5001 is established by using a relay device management table like that shown in FIG. 5. FIG. 5 is a schematic view of the relay device management table. In the relay device management table, each relay device ID that identifies a relay device 30 is managed by associating it with the operation state of a relay device 30, the date and time at which the management system 50 receives the state information indicating the operation state, the IP address of the relay device 30, and the maximum data transfer speed (Mbps) in the relay device 30. For example, the relay device management table shown in FIG. 5 indicates that the operation state of the relay device 30a of the relay device ID “111a” is “ON-LINE”, that the date and time at which the state information is received by the management system 50 is “13:00 10 Nov. 2009”, that the IP address of the relay device 30a is “1.2.1.2”, and that the maximum data transfer speed in the relay device 30a is “100 Mbps”.

Terminal Authentication Management Table

In the non-volatile storage unit 5000, a terminal authentication management DB 5002 consisting of a terminal authentication management table like that shown in FIG. 6 is developed. FIG. 6 is a schematic view of a terminal authentication management table. In the terminal authentication management table, the terminal ID of each of all terminals 10 managed by the management system 50 is managed in association with a password. A terminal ID is information that identifies a terminal 10 and a password is information that is used to authenticate the terminal 10. For example, the terminal authentication management table shown in FIG. 6 indicates that the terminal ID of the terminal 10aa is “10aa” and the password for it is “aaaa”.

A terminal ID and a relay device ID of the first embodiment represent identification information, such as language, letters, symbols or various marks, used to uniquely identify a terminal 10 and a relay device 30. Alternatively, a terminal ID or a relay device ID may be identification information that is a combination of at least two types of information among language, letters, symbols or various marks.

Terminal Management Table

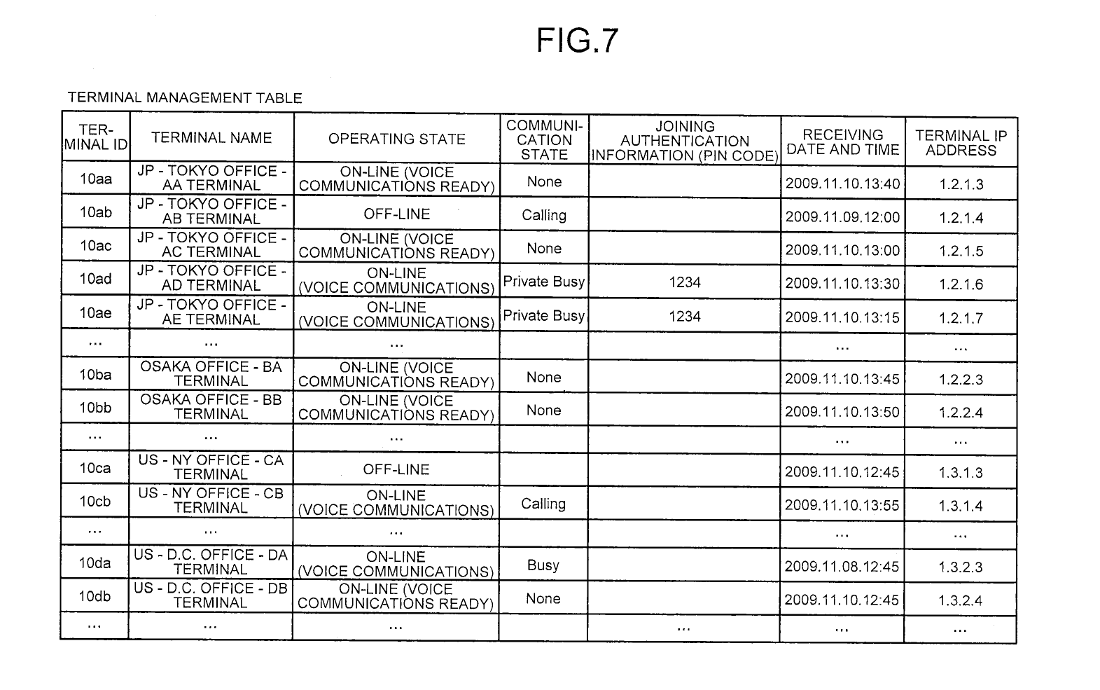

In the non-volatile storage unit 5000, a terminal management DB 5003 consisting of a terminal management table shown in FIG. 7 is developed. FIG. 7 is a schematic view of a terminal management table. In the terminal management table, the terminal ID of each terminal 10 is managed in association with a terminal name, the operation state of the terminal 10, the state of communication with another terminal, joining authentication information (PIN code), the date and time at which the management system 50 received login request information, and the IP address of the terminal 10.

The operation state is indicated as On-line where communications can be made or communications are being made; or Off-line where communications cannot be made.

The communication state includes “Calling” indicating a state where a terminal 10 is calling for another terminal 10, i.e., a state where a terminal 10 has transmitted information of a request to start a session used for a videoconference to another terminal 10 and is waiting for a response; “Ringing” indicating a state where a terminal 10 is called for by another terminal, i.e., where a terminal 10 has received start request information from another terminal 10 but has not completed a response to the received start request information; “Accepted” indicating a state where a terminal 10 has completed a response as permission to start request information from another terminal 10 but a session has not been established, or where a terminal 10 has received a response as permission to start request information transmitted by the terminal 10 but a session has not been established; “Busy” indicating a state where a session with another terminal 10 has been established and contents data in a TV conference is being transferred; and “None” indicating a state where a terminal 10 is not communicating with another terminal and is in a standby state.

The communication states correspond to a session without joining restriction that is established according to start request information that contains restriction information that indicates that there is no restriction on joining. Furthermore, the management system 50 according to the first embodiment manages the communication state corresponding to a session with joining restriction, which is established according to start request information including restriction information indicating that there is a restriction on joining, as a communication state that is different from the communication state corresponding to a session without joining restriction. In other words, corresponding to “Calling”, “Ringing”, “Accepted” and “Busy” for sessions without joining restriction, there are “Private Calling”, “Private Ringing”, “Private Accepted” and “Private Busy” as communication states for a session with a joining restriction. As described above, the communication state is specified and managed depending on whether there is a joining restriction, the management system 50 according to the first embodiment can specify whether there is a joining restriction according to the communication state.

The joining authentication information is information for authenticating joining to a session with a joining restriction, and thus the joining authentication information is registered for terminals whose communication state is indicated as “Private Calling”, “Private Ringing”, “Private Accepted” and “Private Busy” indicating sessions with a joining restriction. In the first embodiment, a PIN code that is a combination of alphabet, number and symbol is used as joining authentication information. However, the joining authentication information is not limited to this.

For example, the terminal management table shown in FIG. 7 indicates that, regarding a terminal 10ad whose terminal ID is “10ad”, the terminal name is “JP—TOKYO OFFICE—AD TERMINAL”, the operation state is “On-line (calling)”, the communication state is “Private Busy” indicating that contents data is being transferred in a session with a joining restriction, the joining authentication information is “1234”, the data and time at which the management system 50 received login request information is “1330 10th Nov. 2009”, and the IP address of the terminal 10ad is “1.2.1.6”.

Destination List Management Table

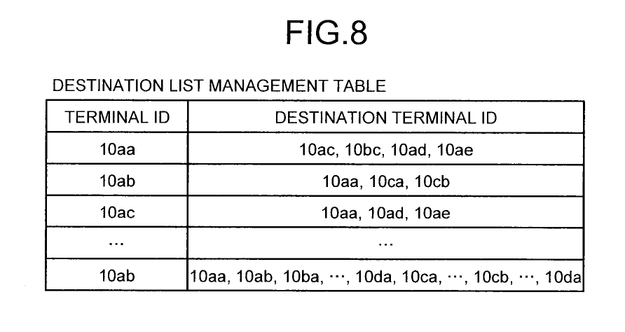

In the non-volatile storage unit 5000, a destination list management DB 5004 consisting of a destination list management table like that shown in FIG. 8 is developed. FIG. 8 is a schematic view of a destination list management table. In the destination list management table, the terminal ID of a start requesting terminal that is a terminal 10 that transmitted information of a request to start a session used for a TV conference involving voice communications that is managed by the management system 50 is managed in association with terminal IDs each identifying a destination terminal candidate that is a terminal 10 serving as a candidate of the destination to which contents data is transmitted by the requesting terminal 10. For example, the destination list management table shown in FIG. 8 indicates that destination terminal candidates to which a terminal (terminal 10aa) whose terminal ID is “10aa” can make a request to start a TV conference are a terminal 10ac whose terminal ID is “10ac”, a terminal 10bc whose terminal ID is “10bc”, a terminal 10ad whose terminal ID is “10ad”, and a terminal 10ae whose terminal ID is “10ae”. The destination terminal candidates are updated by adding or deleting a terminal(s) according to an addition or deletion demand from the start requesting terminal to the management system 50.

Session Management Table

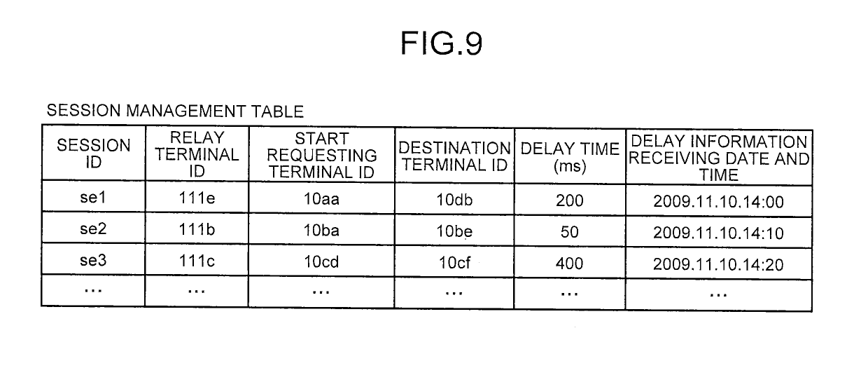

In the non-volatile storage unit 5000, a session management DB 5005 consisting of a session management table like that shown in FIG. 9 is developed. FIG. 9 is a schematic view of the session management table. In the session management table, each session ID that identifies a session in which contents data is transferred between terminals is managed in association with the relay device ID of a relay device 30 that is used to relay contents data in the session, the terminal ID of a start requesting terminal from which session start request information was transmitted, the terminal ID of a destination terminal that is specified as a peer in the session start request information, a delay (ms) caused when the destination terminal receives image data, and the date and time at which the management system 50 received the delay information indicating the delay and transmitted from the destination terminal. For example, the session management table shown in FIG. 9 indicates that the relay device 30e (a relay device ID “111e”) selected for the session that is caused to run using a session ID “sel” relays contents data between the start requesting terminal (the terminal 10aa) whose terminal ID is “10aa” and the destination terminal (the terminal 10db) whose terminal ID is “10db”, and that the delay of the image data in the destination terminal (the terminal 10db) at “1400 10th Nov. 2009” is 200 (ms). When a TV conference is carried out between two terminals 10, the data and time at which delay information is received may be managed according to the delay information that is transmitted not from the destination terminal but from the start requesting terminal. However, when a TV conference is carried out between three or more terminals 10, the data and time at which delay information is received may be managed according to the delay information that is transmitted from the terminal 10 that receives contents data.

Quality Management Table

In the non-volatile storage unit 5000, a quality management DB 5007 consisting of a quality management table is developed. In the quality management table, the image quality of image data (quality of image) that is relayed by the relay device 30 is managed in association with the delay (ms) of the image data in the start requesting terminal or the destination terminal.

(Relay Device Selection Management Table)

In the non-volatile storage unit 5000, a relay device selection management DB 5008 consisting of a relay device selection management table is developed. In the relay device selection management table, each of the terminal IDs of all terminals 10 that are managed by the management system 50 is managed in association with the relay device ID of the relay device 30 that is used to relay contents data.

State Change Management Table

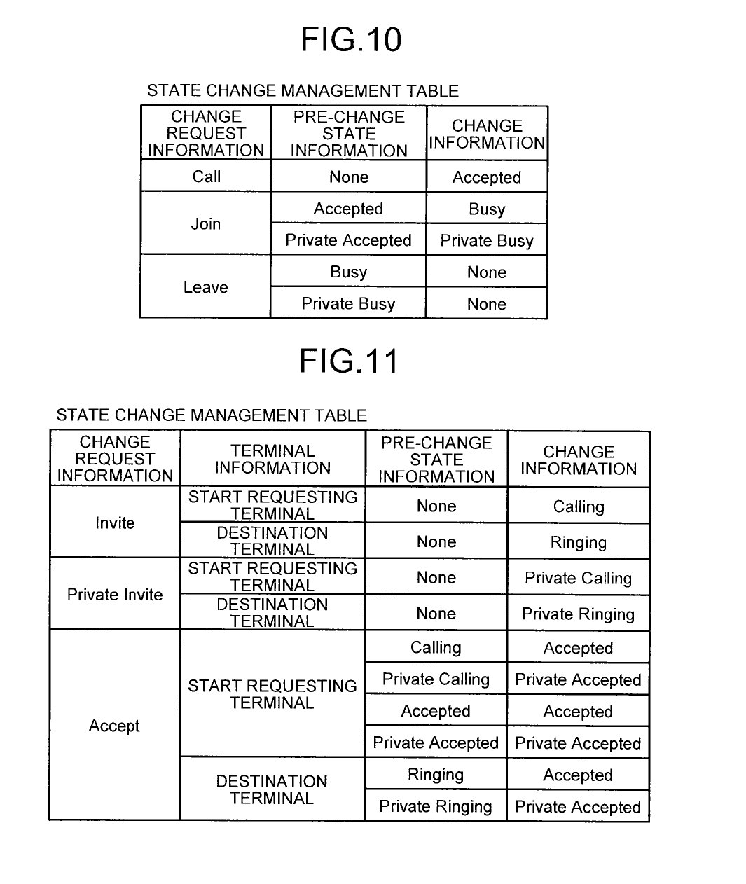

In the non-volatile storage unit 5000, a state change management DB 5009 consisting of a state change management table like that shown in FIGS. 10 and 11 is developed. FIGS. 10 and 11 are schematic views of the state change management table. In the state change management table shown in FIG. 10, change request information indicating a request to change the state of communications between terminals, pre-change state information indicating the communication state before being changed by the state manager 53, and change information indicating the communication state after being changed by the state manager 53 are managed in association with one another. In the state change management table shown in FIG. 11, change request information, terminal information that identifies a state requesting terminal and a destination terminal, pre-change state information and change information are managed in association with one another.

The state change management table shown in FIG. 11 indicates that, upon receiving change request information “Invite”, the management system 50 changes the communication state “None” of the start request terminal before being changed to “Calling” and changes the communication state “None” of the start destination terminal before being changed to “Ringing”. The change request information includes “Invite”, “Private Invite”, and “Accept” shown in FIG. 11 and “Join”, “Call”, and “Leave” shown in FIG. 10.

“Invite” is information that is contained in start request information, i.e., change request information associated with transmission of the start request information. “Accept” is change request information that is associated with receiving of a response to the start request information and that indicates permission to establish a session. “Join” is change request information that is associated with completion of establishment of a session corresponding to the start request information and that indicates a request to start relaying contents data. “Call” is information contained in a joining request, i.e., change request information that is associated with transmission of a joining request, indicating a request to join the running session. “Leave” is change request information that indicates a request to end a session.

Each Functional Unit of Management System

Each functional unit of the management system 50 will be described in detail below. Descriptions will be provided for each unit of the management system 50 as well as the relationship between each unit of the management system 50 and the main components among the components shown in FIG. 3 for enabling each unit of the management system 50.

The transmitter/receiver 51 is enabled by using the network I/F 209 shown in FIG. 3. The transmitter/receiver 51 transmits/receives various types of data (or information) to/from other terminals, devices, or systems via the communication network 2. The terminal authentication unit 52 performs terminal authentication by searching the terminal authentication management table (see FIG. 6) in the non-volatile storage unit 5000 with the terminal ID and the password that serve as search keys and are contained in the login request information that is received via the transmitter/receiver 51, and by determining whether the same terminal ID and the same password are managed in the terminal authentication management table.

When the joining determination unit 63 rejects a joining requesting terminal to join a running session, the transmitter/receiver 51 transmits a message of a rejection of joining to the joining requesting terminal. Furthermore, when the joining determination unit 63 rejects a joining requesting terminal to join a running session, the transmitter/receiver 51 transmits a message addressing that there is a terminal that has failed to join the session to all terminals that are joining the running session.

The state manager 53 manages the operation state and the communication state in the terminal management table shown in FIG. 7. In order to manage the operation state of a terminal 10 that has made a request to log in (login requesting terminal), the state manager 53 stores and manages, in the terminal management table (see FIG. 7), the terminal ID of the login requesting terminal, the operation state of the login requesting terminal, joining authentication information (if there is a joining restriction), the time and date at which the management system 50 received the login request information, and the IP address of the login requesting terminal in association with one another. When the user of the terminal 10 turns on the power switch 109 of the terminal 10 from the off state, the state manager 53 then sets the operation state indicating Off-line in the terminal management table (see FIG. 7) to On-line according to the information transmitted from the terminal 10 and addressing that the power was turned on. When the user of the terminal 10 turns off the power switch 109 of the terminal 10 from the ON state, the state manager 53 then sets the operation state indicating On-line in the terminal management table (see FIG. 7) to Off-line according to the information transmitted from the terminal 10 and addressing that the power was turned off.

When the transmitter/receiver 51 receives change request information, which is transmitted by a start requesting terminal or a destination terminal according to start request information for a TV conference, the state manager 53 appropriately changes, according to the change request information, at least one of the communication state and the operation state of at least one of the start requesting terminal and the destination terminal in the terminal management table (see FIG. 7).

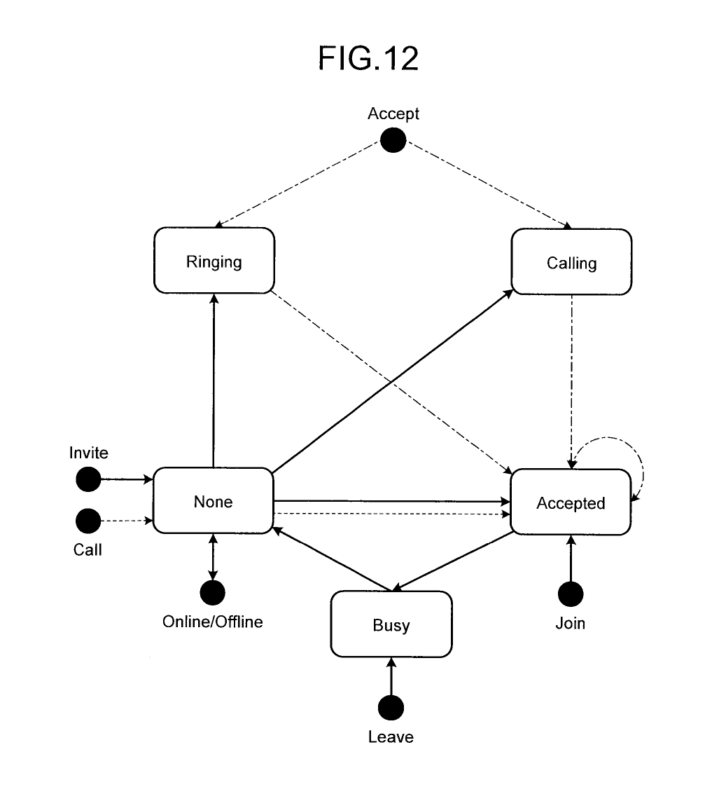

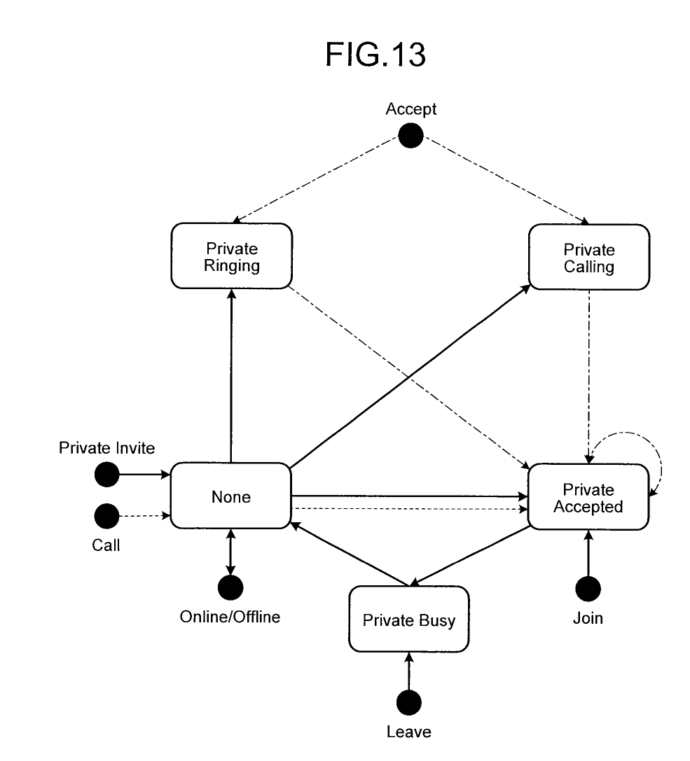

FIGS. 12 and 13 are state transition views of the communication state that is managed by the state manager 53. The state manager 53 changes the communication state of the terminal 10 according to the rules (see FIGS. 12 and 13) for changing the communication state with reference to the state change management table shown in FIGS. 10 and 11.

For example, when change request information “Accept” is received and if the communication state of a terminal 10 is “Ringing” or “Calling” as shown in FIG. 12, the state manager 53 changes the communication state to “Accepted”. If the communication state of the terminal 10 is “Accepted”, the state manager 53 maintains the communication state “Accepted”.

For example, when change request information “Accept” is received and if the communication state of a terminal 10 is “Private Ringing” or “Private Calling” as shown in FIG. 13, the state manager 53 changes the communication state to “Private Accepted”. If the communication state of the terminal 10 is “Private Accepted”, the state manager 53 maintains the communication state “Private Accepted”.

In the first embodiment, examples using the state change management table (see FIGS. 10 and 11) to allow the state manager 53 to change the state will be described, but embodiments are not limited to this. It is satisfactory if a management system program allows the state manager 53 to change the communication state according to the rules for transition of the communication state shown by the state transition diagrams shown in FIGS. 12 and 13.

The terminal extractor 54 extracts the terminal ID by searching the destination list management table (see FIG. 8) with the terminal ID of a target terminal to be processed, such as a terminal 10 that has made a login request, serving as a search key and by reading the terminal ID of a destination terminal candidate that can make voice communications with the target terminal, i.e., that can establish a session. Specifically, the terminal extractor 54 reads the terminal ID of the destination terminal candidate that is associated with the terminal ID of a start requesting terminal that matches the terminal ID of the target terminal in the destination list management table (see FIG. 8).

The terminal extractor 54 searches the destination list management table by using, as a key, the terminal ID of a target terminal and also extracts the terminal ID of another terminal 10 that registers the terminal ID of the target terminal as a destination terminal candidate. Specifically, the terminal extractor 54 reads, from the destination list management table (see FIG. 8), the terminal ID of a start requesting terminal that is associated with the terminal ID of the destination terminal candidate that matches the terminal ID of the target terminal.

The terminal state acquiring unit 55 searches the terminal management table (see FIG. 7) with the terminal ID serving as a search key and reads the operation state and the communication state of each terminal ID. Accordingly, the terminal state acquiring unit 55 can acquire the operation state of destination terminal candidates that can make voice communications with the terminal that made the login request. The terminal state acquiring unit 55 searches the terminal management table and acquires also the operation state of the terminal that made the login request.

The relay device selector 56 performs a process for selecting one of the relay devices 30. Specifically, the relay device selector 56 generates a session ID that identifies a session in which contents data is transferred between terminals. The relay device selector 56 extracts each corresponding relay device ID by searching the relay device selection management table of the relay device selection management DB 5008 according to the terminal ID of a start requesting terminal and the terminal ID of a destination terminal that are contained in the start request information transmitted from the start requesting terminal. The relay device selector 56 selects a relay device 30 by selecting the relay device ID of a relay device 30 whose operation state is “On-line” among the relay devices 30 that are managed in the relay device management table (see FIG. 5).

The session manager 57 stores and manages, in the session management table (see FIG. 9) of the non-volatile storage unit 5000, the session ID that is generated by the relay device selector 56, the terminal ID of the requesting terminal, and the terminal ID of the destination terminal in association with one another.

Furthermore, the session manager 57 searches the session management table (see FIG. 9) using, as a search key, the terminal ID of a joining terminal already joining a target session of a joining request, which is the terminal ID contained in the joining request information, and extracts the session Ida of the target session for the joining request. Specifically, the session manager 57 searches the terminal ID of the start requesting terminal or the terminal ID of the destination terminal that matches the terminal ID of the joining terminal in the session management table (FIG. 9) and extracts the session ID that is associated with the matching terminal ID.

The quality determination unit 58 determines the image quality of image data to be relayed by a relay device 30, by searching the quality management table of the quality management DB 5007 with the delay serving as a search key and by extracting the image quality of corresponding image data. The storing/reading processor 59 is enabled by using the HDD 205 shown in FIG. 3. The storing/reading processor 59 performs a process for storing various types of data in the non-volatile storage unit 5000 or reading various types of data stored in the non-volatile storage unit 5000. Furthermore, the storing/reading processor 59 performs a process for storing various types of data in the volatile storage unit 5100 or reading various types of data stored in the volatile storage unit 5100.

The delay manager 60 extracts a corresponding terminal ID by searching the terminal management table (see FIG. 7) with the IP address of the destination terminal serving as a search key and stores and manages the delay time, which is indicated by the delay information, in the delay time field part in the record containing the extracted terminal ID in the session management table (see FIG. 9).

The change request information determination unit 61 refers to change request information and determines whether the change request information is specific change request information. Specific change request information includes “Invite”, “Private Invite”, and “Accept”. In other words, the specific change request information is the change request information that is stored in the state change management table shown in FIG. 11.

The destination determination unit 62 refers to the destination list management table (see FIG. 8) and determines whether the destination IDs of terminals 10 joining the contents data session sed that are extracted by the terminal extractor 54 include the destination terminal ID of the joining requesting terminal.

When the transmitter/receiver 51 receives a request to join a running session from a given terminal, the joining determination unit 63 refers to the restriction information corresponding to the running session and determines whether to permit or reject the joining requesting terminal, from which the joining request information was transmitted, to join the running session. More specifically, when the joining request information is a request to join a running session that is established by start request information specifying that there is a joining restriction, the joining determination unit 63 compares the joining authentication information that is received from the start requesting terminal and the joining authentication information that is received from the joining requesting terminal and, on the basis of the comparison, permits the joining requesting terminal to join the running session or requests the joining requesting terminal for the joining authentication information. In other words, when the joining authentication information that is received from the start requesting terminal and the joining authentication information that is received from the joining requesting terminal match, the joining determination unit 63 permits the joining requesting terminal to join the running session. When the joining request information is a request to join the running session that has been established by the start request information specifying that there is no joining restriction, the joining determination unit 63 also permits the joining requesting terminal to join the running session.

When the joining authentication information that is received from the start requesting terminal and the joining authentication information that is received from the joining requesting terminal do not match, the joining determination unit 63 does not immediately reject the joining requesting terminal to join the running session and requests the joining requesting terminal to re-enter joining authentication information. When the number of times the joining authentication information that is received from the start requesting terminal and the joining authentication information that is received from the joining requesting terminal do not match reaches a given upper limit, the joining determination unit 63 rejects the joining requesting terminal to join the running session.

The upper limit of the number of times of mismatching is previously registered in the terminal management DB 5003. The upper limit is not limited to this and the user may specify an arbitrary number of times as the number of times of mismatching.

The terminal management DB 5003 includes a mismatching counter that counts the number of times of mismatching. The terminal management DB 5003 counts up the counter by 1 every time joining authentication information is received from the same joining requesting terminal.

<<Processes and Operations According to First Embodiment>>

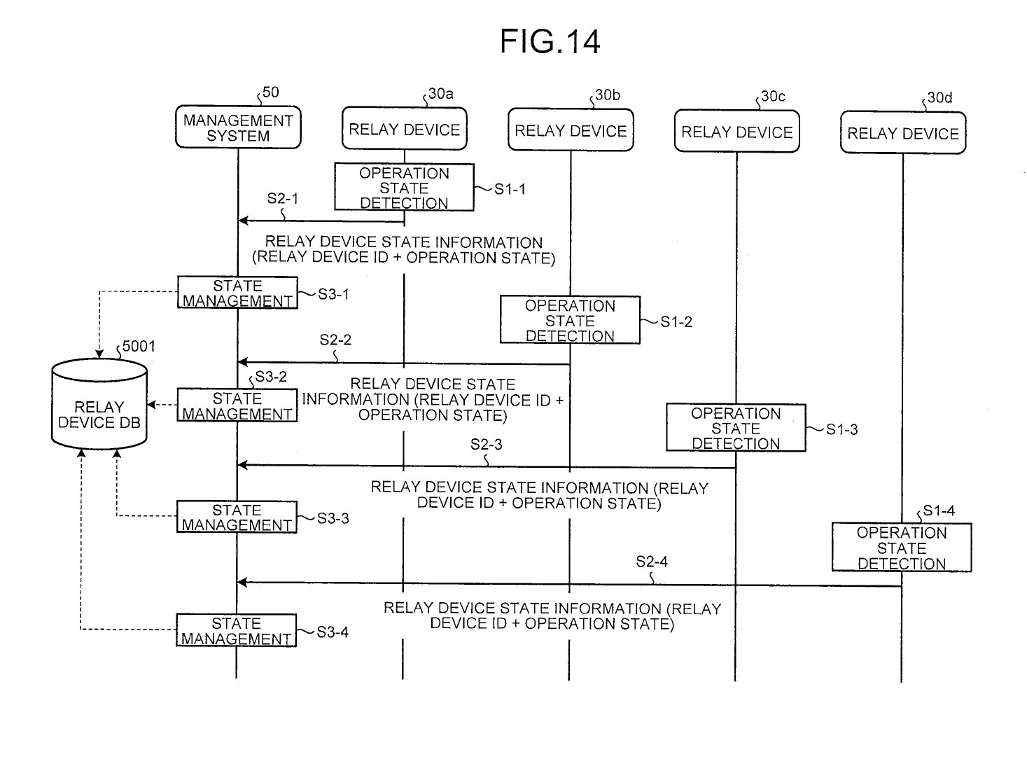

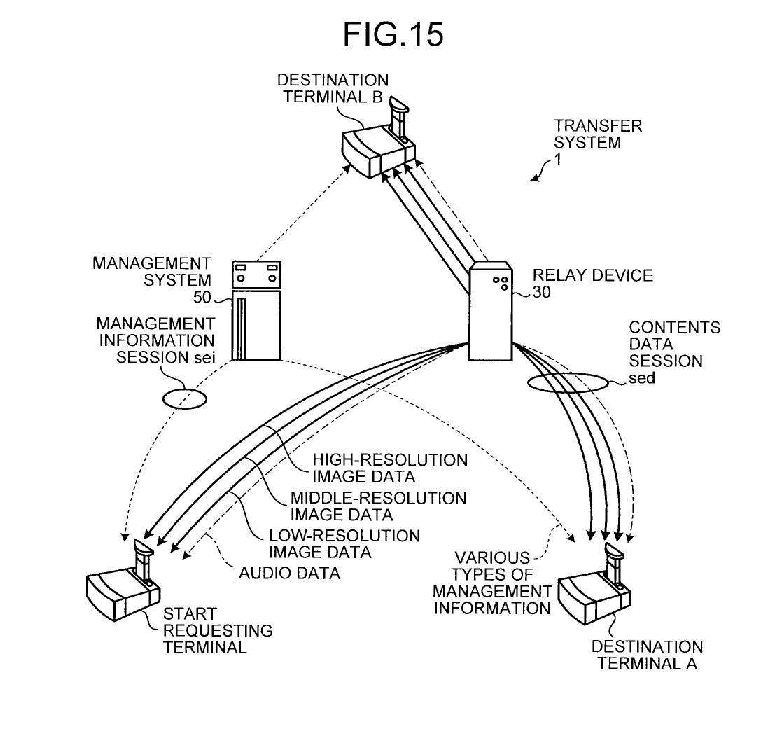

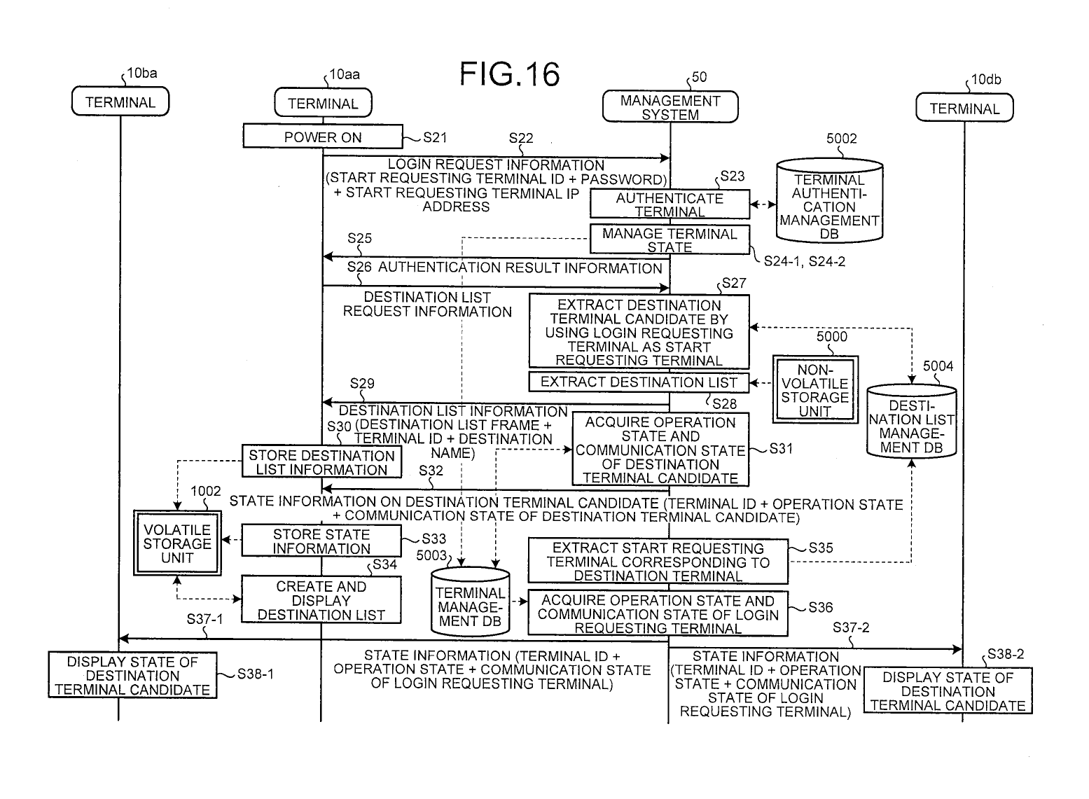

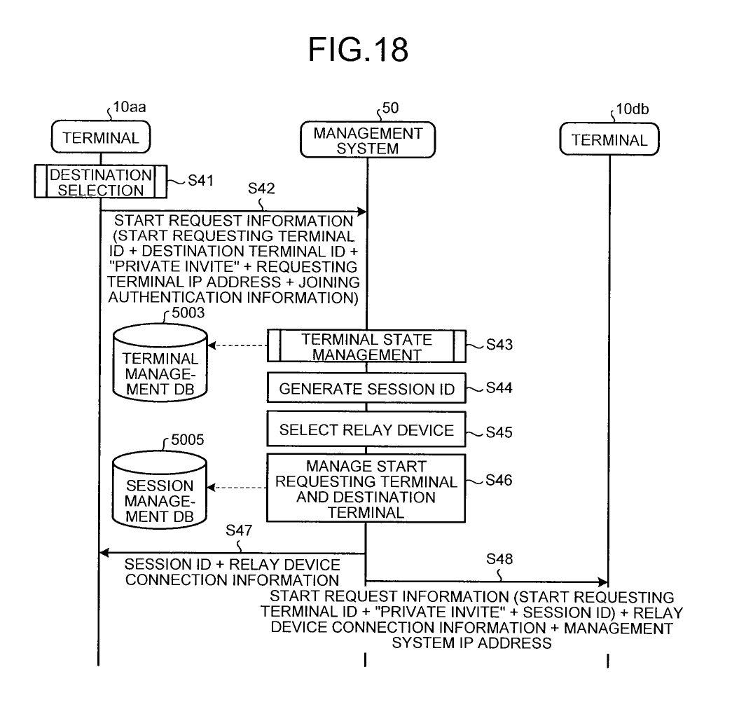

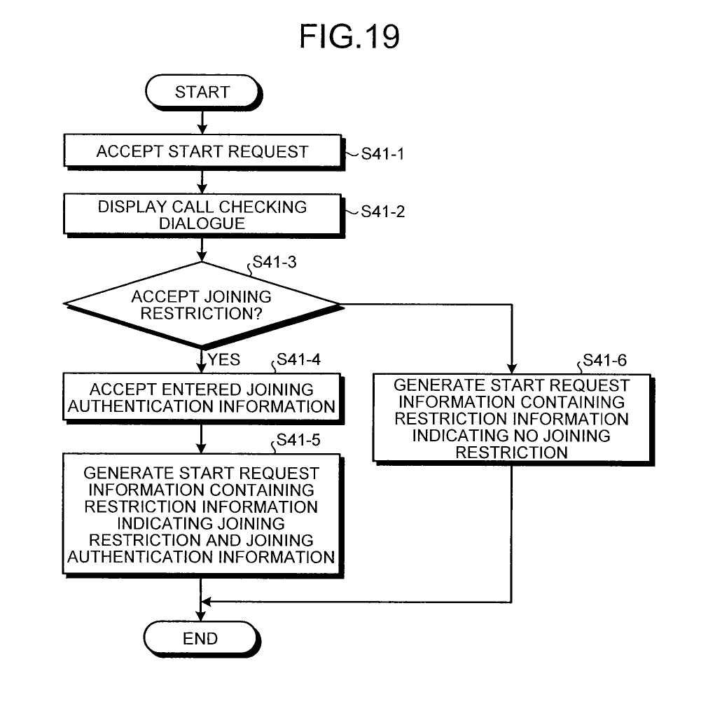

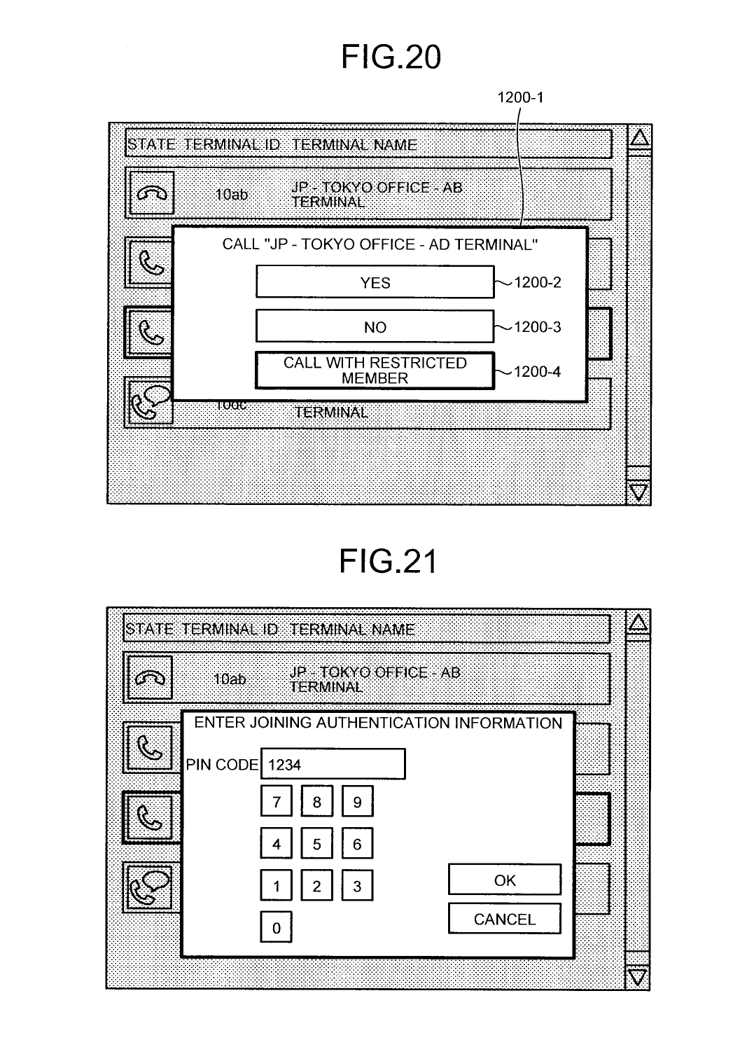

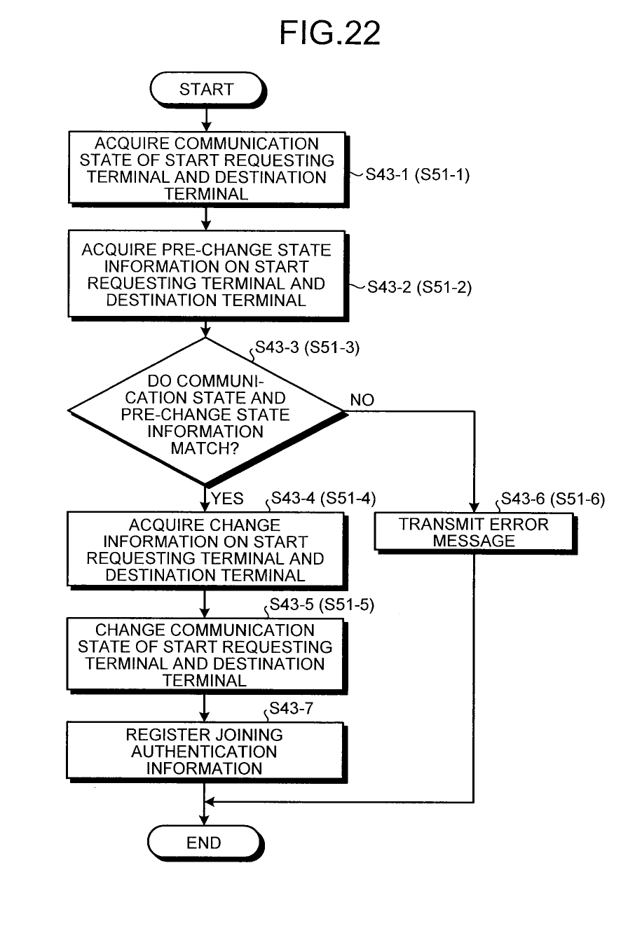

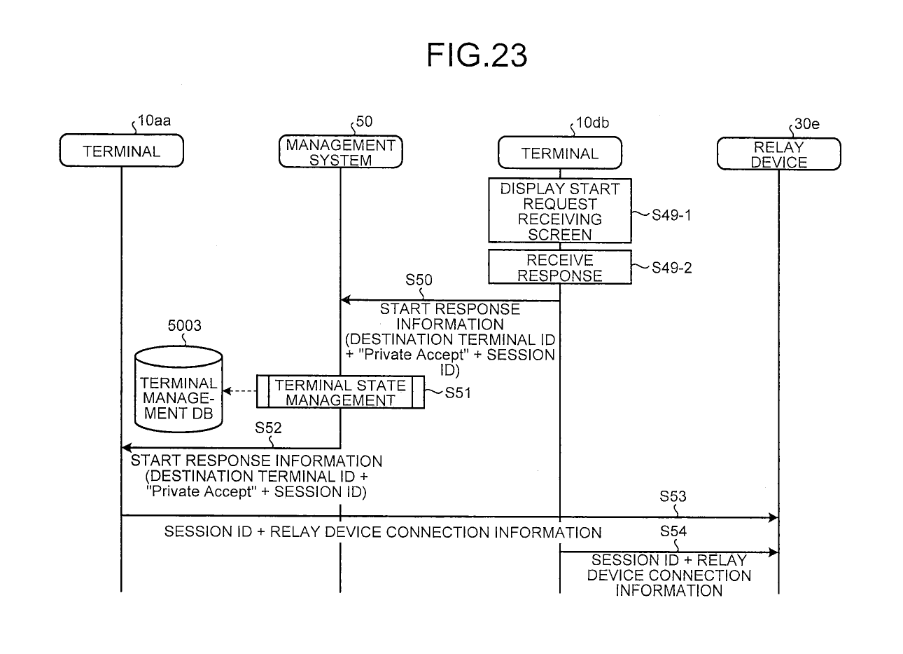

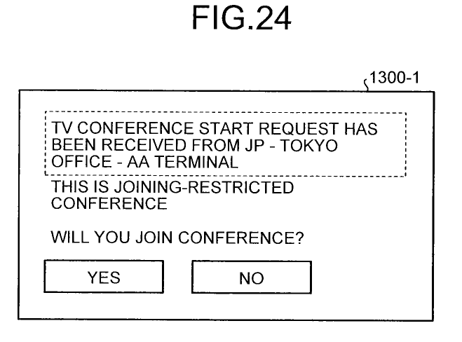

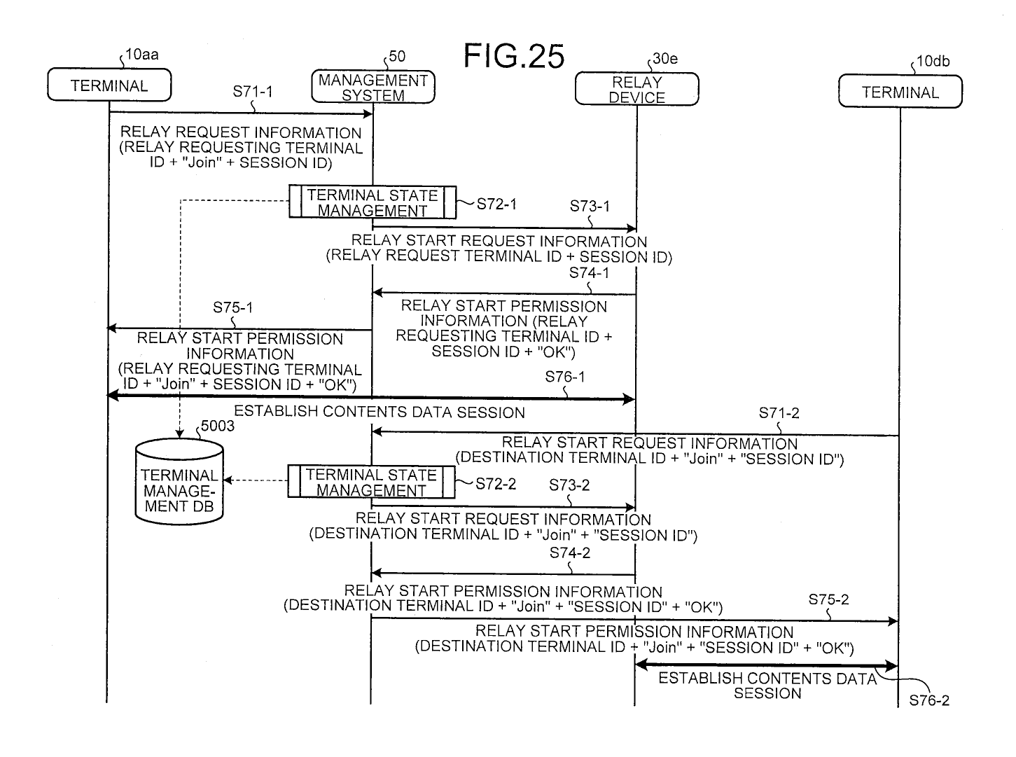

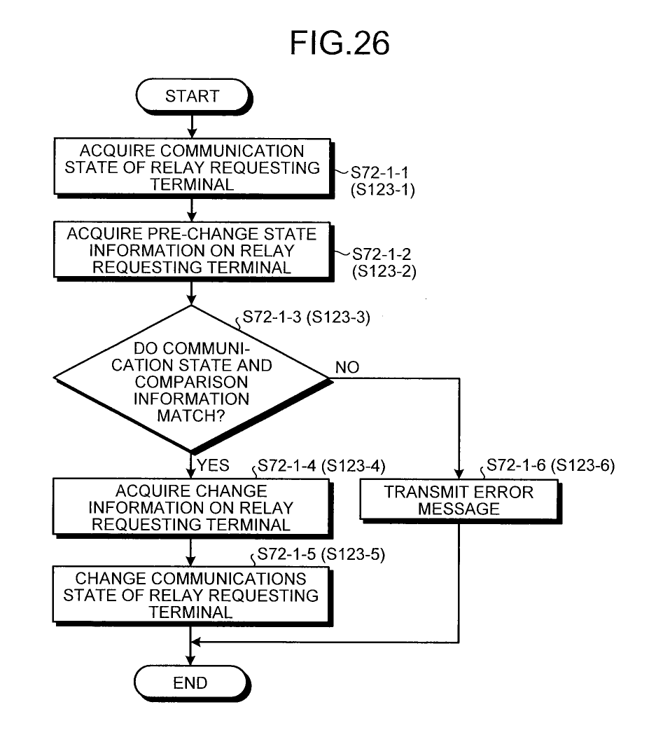

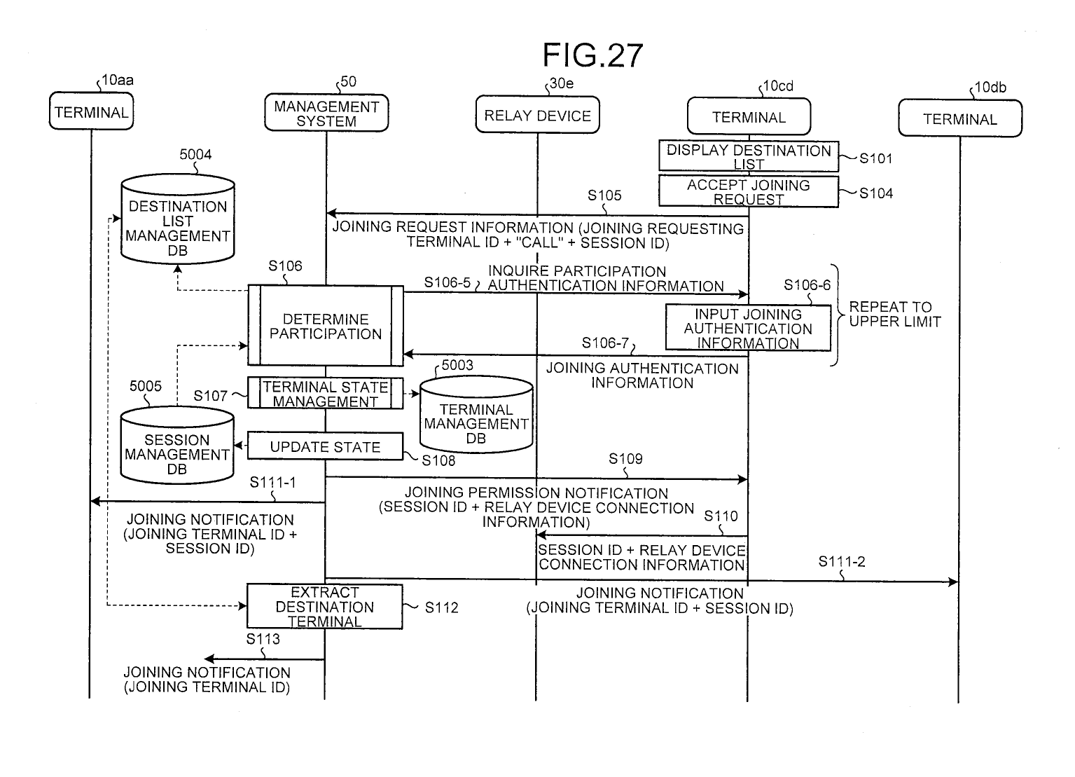

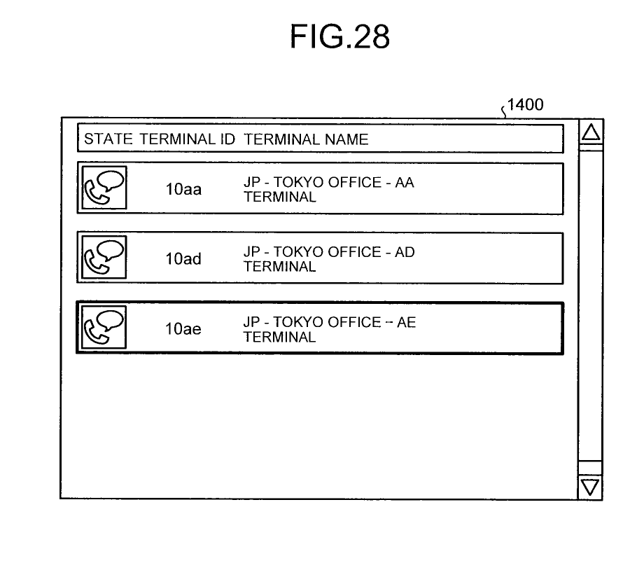

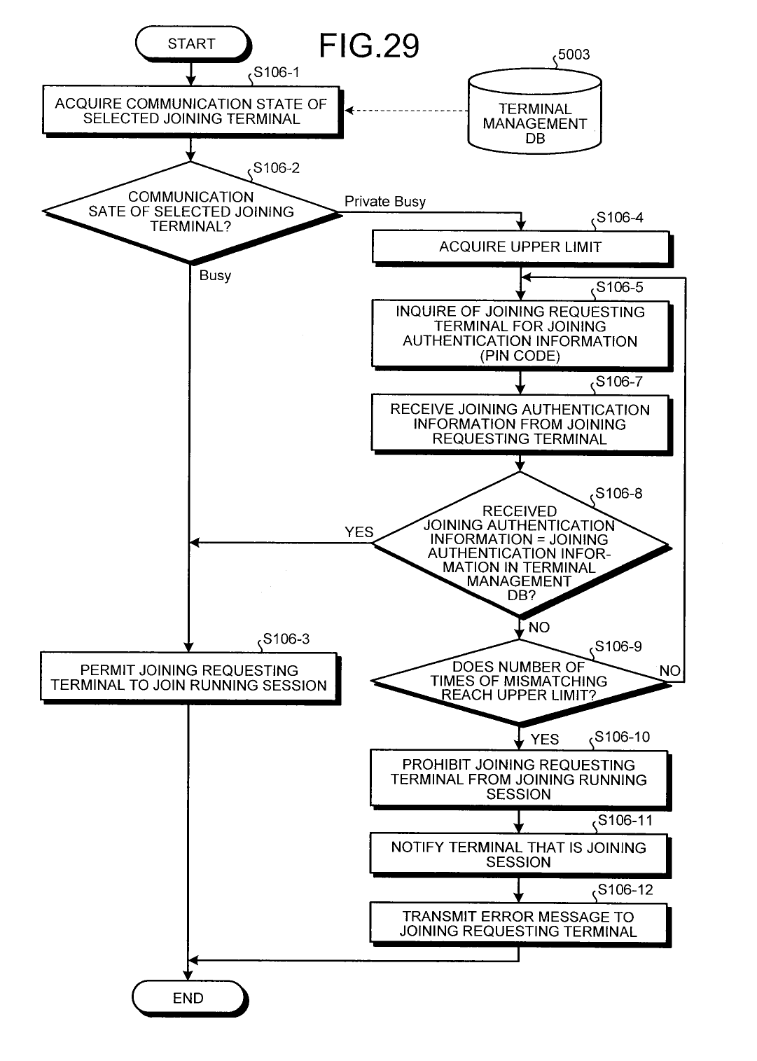

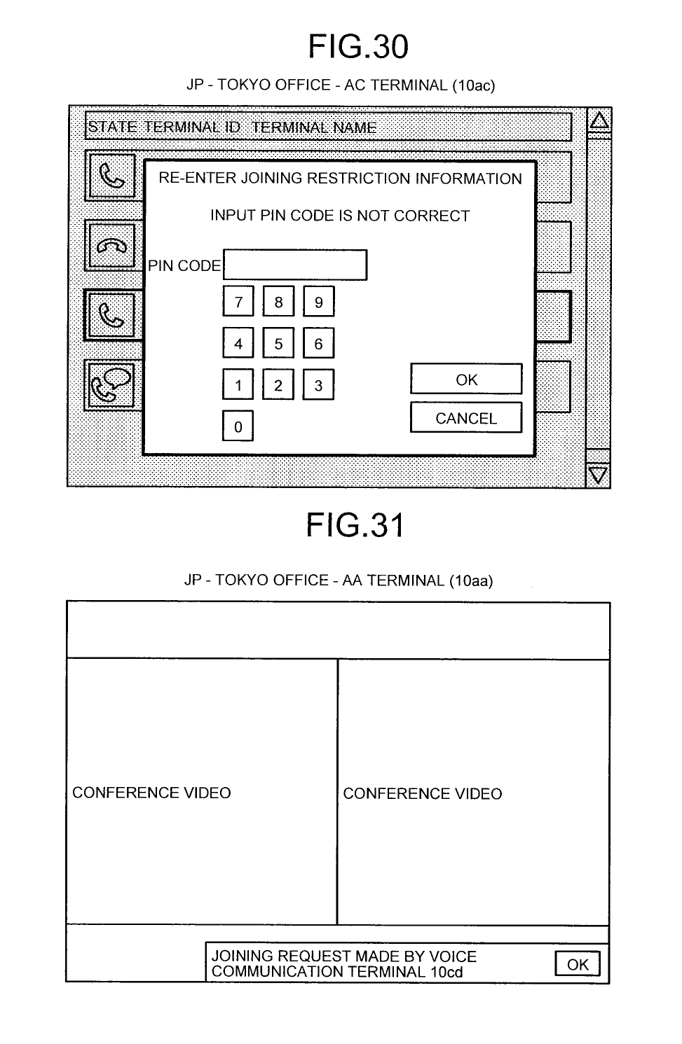

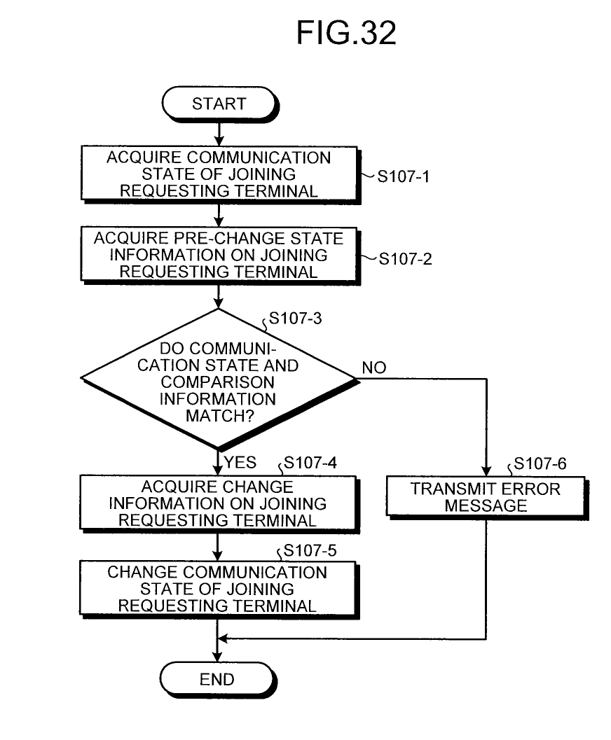

The configuration and functions (or means) of the transfer system 1 according to the first embodiment are described above. With reference to FIGS. 14 to 32, the processing method employed by the transfer system 1 according to the first embodiment will be described. FIG. 14 is a sequence chart of a process for managing state information indicating the operation state of each relay device. FIG. 15 is a schematic diagram of the state where image data, audio data, and various types of management information are transmitted and received in the transfer system. FIG. 16 is a sequence chart of a preparatory process for starting voice communications between terminals. FIG. 17 is a diagram of an example of display of a destination list of the first embodiment. FIG. 18 is a sequence chart of a process for making a request to start communications. FIG. 19 is a flowchart of a detailed procedure performed by a start requesting terminal in a destination selecting process. FIG. 20 is a diagram of an example of display of an outgoing call checking dialogue. FIG. 21 is a diagram of an example of display of a joining authentication information entering screen. FIG. 22 is a flowchart of a procedure for changing the communication state. FIG. 23 is a sequence chart of a process for accepting the request to start communications. FIG. 24 is a diagram of an example of display of a start request accepting screen. FIG. 25 is a sequence chart of a process for making a request to relay contents data. FIG. 26 is a flowchart of a procedure for changing the communication state. FIG. 27 is a sequence chart of a process for transmitting information of a request to join a contents data session. FIG. 28 is a diagram of a display example of a destination list. FIG. 29 is a flowchart of a procedure for joining determination based on the communication state. FIG. 30 is a diagram of an example of a joining authentication information re-entering screen. FIG. 31 is a diagram of an example of display of a message on the display 120 of the terminal 10aa that is joining a session. FIG. 32 is a flowchart of a procedure for changing the communication state.

First, the process for managing the state information that indicates the state of each relay device 30 and that is transmitted from each relay device 30 to the management system 50 will be described with reference to FIG. 14. In each relay device 30, the state detector 32 shown in FIG. 4 regularly detects the operation state of the relay device 30 (steps S1-1 to S1-4). In order for the management system 50 to manage the operation state of each relay device 30 in real time, the transmitter/receiver 31 of each relay device 30 regularly transmits the state information to the management system 50 via the communication network 2 (steps S2-1 to S2-4). The state information contains the relay device ID of each relay device 30 and the operation state that is detected by the state detector 32 of the relay device 30 corresponding to the relay device ID. In the first embodiment, as shown in FIG. 5, while the relay devices (30a, 30b, and 30d) operate normally and are “On-line”, the relay device 30c is in operation but a failure occurs in the program for performing the relay operation of the relay device 30c and thus is “Off-line” is shown.

In the management system 50, the transmitter/receiver 51 receives state information that is transmitted from each relay device 30 and, for each relay device ID, state information is stored and managed in the relay device management table (see FIG. 5) of the non-volatile storage unit 5000 via the storing/reading processor 59 (steps S3-1 to S3-4). In the relay device management table like that shown in FIG. 5, the operation state that is any one of “On-line”, “Off-line” and “Failure” is stored for each relay device ID. For each relay device ID, the date and time at which the management system 50 received state information is also stored and managed. When state information is not transmitted from the relay devices 30, the operation state field part and the receiving date and time field part in each record of the relay device management table shown in FIG. 5 are blank or indicate the previous operation state and receiving date and time.

The scheme of a state where contents data and various types of management information are transmitted/received in the transfer system 1 will be described with reference to FIG. 15. As shown in FIG. 15, in the transfer system 1, a management information session sei for transmitting/receiving various types of management information is established between a start requesting terminal and destination terminals A and B via the management system 50. Furthermore, four sessions are established between the start requesting terminal and the destination terminals A and B via the relay device 30 in order to transmit/receive four types of data, i.e., high-resolution image data, medium-resolution image data, low-resolution image data, and audio data. These four sessions are collectively shown as the contents data session sed. In other words, the contents data session sed is a session used for a TV conference. The scheme for the session is only an example and it is not necessary to use separate image data sessions according to the resolution. For example, three or less sessions or five or more sessions may be used.

A preparatory process for transmitting/receiving management information before the terminal 10aa starts voice communications will be described. FIG. 16 shows a process for transmitting/receiving all various types of management information via the management information session sei.

First, when a user of the terminal 10aa turns on the power switch 109 shown in FIG. 2, the operational-entering accepting unit 12 shown in FIG. 4 accepts the power-on and turns on the power (step S21). The acceptance of the power-on triggers the login requesting unit 13 to automatically transmit login request information indicating a login request from the transmitter/receiver 11 to the management system 50 via the communication network 2 (step S22). The login request information contains the terminal ID for identifying the requesting terminal 10aa and a password. The terminal ID and the password are data that is read from the non-volatile storage unit 1000 via the storing/reading processor 19 and transmitted to the transmitter/receiver 11. When login request information is transmitted from the terminal 10aa to the management system 50, the receiving management system 50 can know the IP address of the transmitting terminal 10aa.

The terminal authentication unit 52 of the management system 50 then performs terminal authentication by searching the terminal authentication management table (see FIG. 6) of the non-volatile storage unit 5000 by using, as search keys, the terminal ID and the password that are contained in the login request information received via the transmitter/receiver 51 and by determining whether the same terminal ID and password are managed in the terminal authentication management DB 5002 (step S23).

When the terminal authentication unit 52 determines that a login request was made by a terminal 10 with valid authority because the same terminal ID and the same password are managed, the state manager 53 stores, for each record indicated by the terminal ID and terminal name of the terminal 10aa, the receiving date and time at which the login request information was received and the IP address of the terminal 10aa in association with each other in the terminal management table (see FIG. 7) (step S24-1).

Accordingly, in the terminal management table shown in FIG. 7, the terminal ID “10aa” is managed in association with the receiving data “2009.11.10.13:40” and the terminal IP address “1.2.1.3”.

The state manager 53 sets the operation state “On-line” and the communication state “None” of the terminal 10aa and stores, for each record indicated by the terminal ID and terminal name of the terminal 10aa, the operation state and the communication state in association with each other in the terminal management table (see FIG. 7) (step S24-2). Accordingly, in the terminal management table shown in FIG. 7, the terminal ID “10aa” is managed in association with the operation state “On-line” and the communication state “None”.

The transmitter/receiver 51 of the management system 50 transmits authentication result information indicating the result of authentication by the terminal authentication unit 52 to the login requesting terminal (the terminal 10aa), which made the login request, via the communication network 2 (step S25). Next, the case will be described below where the terminal authentication unit 52 determines that the terminal has valid authority in the first embodiment.

When the terminal 10aa receives authentication result information indicating that it has valid authority, the transmitter/receiver 11 transmits destination list request information indicating a request for a destination list to the management system 50 via the communication network 2 (step S26). Accordingly, the transmitter/receiver 51 of the management system 50 receives the destination list request information.

The terminal extractor 54 searches the destination list management table (see FIG. 8) using, as a search key, the terminal ID “10aa” of the login requesting terminal (the terminal 10aa) that made a login request and reads and thus extracts the terminal ID of a destination terminal candidate with which the login requesting terminal (the terminal 10aa) can make voice communications, i.e., that can establish a session (step S27). The terminal extractor 54 searches the terminal management table (see FIG. 7) with the extracted terminal ID as a search key and reads and thus extracts the terminal name corresponding to the terminal ID, i.e., the terminal name of the destination terminal candidate. Here, the terminal IDs (“10ab”, “10ac”, “10ad”, and “10ae”) of the destination terminal candidates (the terminals (10ab, 10ac, 10ad, and 10ae) corresponding to the terminal ID “10aa” of the start requesting terminal (the terminal 10aa) and the corresponding terminal names (“JP—TOKYO OFFICE—AB TERMINAL”, “JP—TOKYO OFFICE—AC TERMINAL”, “JP—TOKYO OFFICE—AD TERMINAL”, and “JP—TOKYO OFFICE—AE TERMINAL”) are extracted.

The transmitter/receiver 51 of the management system 50 reads the data of the destination list frame (the data of an destination list frame 1100-1 shown in FIG. 17) from the non-volatile storage unit 5000 via the storing/reading processor 59 (step S28) and transmits, to the start requesting terminal (the terminal 10aa), the destination list frame and the “destination list information (destination list frame, terminal ID, and terminal name)” containing the terminal ID and the terminal name of the destination terminal candidate that are extracted by the terminal extractor 54 (step S29). Accordingly, in the start requesting terminal (the terminal 10aa), the transmitter/receiver 11 receives the destination list information and the storing/reading processor 19 stores the destination list information in the volatile storage unit 1002 (step S30).

As described above, in the first embodiment, each terminal does not manage the destination list information and the management system 50 generally manages the destination list information on all terminals. Thus, even if a new terminal 10 is contained in the transfer system 1 or new type of terminals 10 are contained in the transfer system 1 instead of the existing terminal 10 or even if the appearance of the destination list frame is changed, the management system 50 generally deals with such changes so that each terminal can save the time for changing the destination list information.

The terminal state acquiring unit 55 of the management system 50 searches the terminal management table (see FIG. 7) using, as search keys, the terminal IDs (“10ab”, “10ac”, “10ad”, and “10ae”) of destination terminals that are extracted by the terminal extractor 54 and reads the operation state and the communication state corresponding to each terminal ID that is extracted by the terminal extractor 54, thereby acquiring the operation state and communication state of each of the terminals (10ab, 10ac, 10ad, and 10ae) serving as destination terminal candidates (step S31).

The transmitter/receiver 51 transmits the terminal IDs that are used as search keys at step S31 and the state information that contains the operation state and communication state of the corresponding destination terminal candidates to the login requesting terminal via the communication network 2 (step S32). Specifically, at step S32, the transmitter/receiver 51 transmits the state information that contains the terminal ID (“10ab”) serving as a search key and the operation state “Off-line” of the destination terminal candidate (the terminal 10ab) to the login requesting terminal (the terminal 10aa). When the operation state is “Off-line”, the communication state is not contained in the state information. As part of step S32, the transmitter/receiver 51 transmits the state information on all destination terminal candidates, such as the terminal ID “10ac”, the operation state “On-line” of the corresponding destination terminal candidate (the terminal 10ac), and the state information containing the communication state “Calling” to the login requesting terminal (the terminal 10aa).

The storing/reading processor 19 of the login requesting terminal (the terminal 10aa) sequentially stores the state information, which is received from the management system 50, in the volatile storage unit 1002 (step S33). Accordingly, by receiving the state information on each of the terminals, the login requesting terminal (the terminal 10aa) can acquire the current operation state and communication state of the terminal 10ab etc. that are destination terminal candidates that can make communications with the login requesting terminal (the terminal 10aa) serving as the start requesting terminal.

According to the destination list information and the state information on terminals that are stored in the volatile storage unit 1002, the destination list creator 20 of the login requesting terminal (the terminal 10aa) creates a destination list that reflects the operation state and communication state of the terminal 10 serving as destination terminal candidate. The display controller 16 displays at given timing the destination list on the display 120aa shown in FIG. 1 (step S34).

FIG. 17 is a diagram of an example of display of the destination list. As shown in FIG. 17, the destination list is a display screen that contains, in the destination list frame 1100-1, terminal IDs 1100-2 of destination terminal candidates, terminal names 1100-3, icons 1100-4a to 1100-4c that reflect the state information, etc.

The icons include an Off-line icon 1100-4a indicating Off-line where voice communications cannot be made, a voice communications ready icon 1100-4b indicating On-line where voice communications are ready, and a voice communication icon 1100-4c indicating On-line where voice communications are being made.

When the operation state of a destination terminal candidate is “On-line” and its communication state is “None”, the destination list creator 20 allocates the destination terminal candidate with the voice communication ready icon 1100-4b. When the operation state of a destination terminal candidate is “On-line” and its communication state is other than “None”, the destination list creator 20 allocates the destination terminal candidate with the voice communication icon 1100-4c. When the operation state of a destination terminal candidate is “Off-line”, the destination list creator 20 allocates the destination terminal candidate with the Off-line icon 1100-4a.

Here reference is made to FIG. 16. The terminal extractor 54 of the management system 50 searches the destination list management table (see FIG. 8) with the terminal ID “10aa” of the login requesting terminal (the terminal 10aa) serving as a reference key and extracts the terminal ID of another terminal (start requesting terminal) for which the terminal ID “10aa” of the login requesting terminal (the terminal 10aa) is registered as a destination terminal candidate (step S35). In the destination list management table shown in FIG. 8, the extracted terminal IDs of other requesting terminals are “10ab”, “10ac” and “10db”.

The terminal state acquiring unit 55 of the management system 50 then searches the terminal management table (see FIG. 7) with the terminal ID “10aa” of the login requesting terminal (the terminal 10aa) serving as a search key and acquires the operation state and communication state of the login requesting terminal (the terminal 10aa) (step S36).

The transmitter/receiver 51 transmits, to the terminal whose operation state is “On-line” in the terminal management table (see FIG. 7) among the terminals (10ab, 10ac, and 10db) of the terminal IDs (“10ab”, “10ac”, and “10db”) that are extracted at step S35 (here, the operation state of the terminals 10ac and 10db are “On-line”), state information that contains the terminal ID “10aa”, the operation state “On-line”, and the communication state “Private Busy” of the login requesting terminal (the terminal 10aa) that are acquired at step S36 (steps S37-1 and S37-2). The terminal 10ac and the terminal 10db display, on the display 120, the state information on the destination terminal candidate (steps S38-1 and S38-2). When the transmitter/receiver 51 transmits the state information to the terminals (10ac and 10db), it refers to the IP addresses of the terminals that are managed in the terminal management table shown in FIG. 7 according to each terminal ID (“10ac” and “10db”). Accordingly, the terminal ID “10aa”, the operation state “On-line”, and the communication state “None” of the login-requesting terminal (“the terminal 10aa”) can be transmitted to each of the terminals (the terminals (10ac and 10db)) that can make voice communications with a destination that is the login requesting terminal (the terminal 10aa).

As for other terminals 10, when the user turns on the power switch 109 shown in FIG. 2 as in the case of step S21, the operational-entering accepting unit 12 shown in FIG. 4 accepts a power-on and performs the same process as that at steps S22 to S38-1 and S38-2. Thus, descriptions thereof will be omitted.

A process performed by a terminal to make a request to start communications with another terminal will be described with reference to FIG. 18. In FIG. 18, a process for transmitting/receiving all various types of management information via the management information session sei is shown.

With reference to FIG. 18, an example will be described where the terminal 10aa that is permitted to log in as shown in FIG. 16 transmits start request information, i.e., the terminal 10aa operates as a start requesting terminal. According to the state information on the destination terminal candidates that is received at step S32 described in FIG. 16, the terminal 10aa serving as a start requesting terminal can communicate with at least one of terminal whose operation state is “On-line” and whose communication state is “None” among the destination terminal candidates.

When a case is assumed where the terminals (10ab, 10ba, 10db, and 10dc) are extracted as destination terminal candidates at step S31 in the first embodiment, the start requesting terminal (the terminal 10aa) can make voice communications according to the state information received at step S32 with the terminal 10db whose operation state is “On-line” and whose communication state is “None” among the terminals (10ab, 10ba, 10db, and 10dc) serving as destination terminal candidates. A case will be described where the user of the start requesting terminal (the terminal 10aa) selects to start voice communications with the destination terminal (the terminal 10db).

In the state before the process shown in FIG. 18 starts, the display 120aa of the terminal 10aa serving as the start requesting terminal displays the destination list shown in FIG. 17. The user of the start requesting terminal can select a desired peer for voice communications, i.e., a session per, from the destination list.

In the process shown in FIG. 18, first, when the user of the start requesting terminal touches the operation button 108 shown in FIG. 2 to select a destination terminal (the terminal 10db), a destination selection process is performed (step S41).

FIG. 19 is a flowchart of a detailed process performed by the start requesting terminal in the destination selecting process (step S41). When the user touches the operation button 108 to select a destination terminal (the terminal 10db) in the destination list as described above, the operational-entering accepting unit 12 shown in FIG. 4 accepts a request to start voice communications with the specified destination terminal (the terminal 10db), i.e., a session start request (step S41-1). The display controller 16 displays a call checking dialogue 1200-1 shown in FIG. 20 such that it is superposed on the destination list (step S41-2).

The call checking dialogue 1200-1 is a user interface for checking the start request that is accepted at step S41-1 and for specifying whether to restrict terminals to join the session of the start request. The call checking dialogue 1200-1 contains a “YES” button 1200-2 for determining transmission of start request information, a “NO” button 1200-3 for canceling transmission of start request information, and “CALL WITH RESTRICTED MEMBERS” button 1200-4 for specifying a session with a joining restriction.

When the “YES” button 1200-2 is selected, the operational-entering accepting unit 12 accepts the specifying that there is no joining restriction. In contrast, when the “CALL WITH RESTRICTED MEMBERS” button 1200-4 is selected, the operational-entering accepting unit 12 accepts the specifying that there is a joining restriction.

When the specifying that there is no joining restriction is accepted (YES at step S41-3), the display controller 16 displays the joining authentication information entering screen on the display 120. FIG. 21 is a diagram of an example of the joining authentication information entering screen.

The user of the terminal 10aa enters a PIN code as joining authentication information via the joining authentication information entering screen shown in FIG. 21. In other words, before a session is established, the terminal 10aa voluntarily (without inquiry from the management system 50) enters the joining authentication information to transmit it to the management system 50. Here, a reference is made to FIG. 19. The operational-entering accepting unit 12 of the terminal 10aa accepts the entering of the PIN code serving as the joining authentication information from the user via the joining authentication information entering screen and then the management system 50 receives the entered joining authentication information (PIN code) (step S41-4).

The transmitter/receiver 11 of the management system 50 generates start request information that contains the restriction information indicating a joining restriction and the received joining authentication information (PIN code) (step S41-5). The start request information that is generated at step S41-5 contains “Private Invite” that is the restriction information indicating a joining restriction, the terminal ID “10aa” of the start requesting terminal, the terminal ID “10db” of the destination terminal, and the PIN code “1234” serving as joining authentication information.

When the specifying that there is no joining restriction is accepted (NO at step S41-3), the transmitter/receiver 11 generates start request information that contains restriction information indicating that there is no joining restriction (step S41-6). Specifically, the start request information that is generated at step S41-6 indicates a start request and contains “Invite” that is restriction information indicating there is no joining restriction, the terminal ID “10aa” of the start requesting terminal, and the terminal ID “10db” of the destination terminal.

FIG. 18 exemplarily describes a case where “Private Invite” that is restriction information indicating a joining restriction is specified as the start request information. The transmitter/receiver 11 of the terminal 10a shown in FIG. 18 transmits the terminal ID “10aa” of the start requesting terminal (the terminal 10aa), the terminal ID “10db” of the destination terminal (the terminal 10db), and “Private Invite” that indicates a start request and contains restriction information indicating a joining restriction to the management system 50 together with the IP address of the start requesting terminal (step S42). Accordingly, the transmitter/receiver 51 of the management system 50 receives the start request information and knows the IP address “1.2.1.3” of the start requesting terminal (the terminal 10aa) that transmits the start request information.

According to the terminal ID “10aa” of the start requesting terminal (the terminal 10aa) and the terminal ID “10db” of the destination terminal (the terminal 10db) that are contained in the start request information, the start manager 53 changes the communication state field part of the record where the terminal ID “10aa” and the terminal ID “10db” are contained in the terminal management table of the terminal management DB 5003 (see FIG. 7) (step S43).

Here, the process at step S43 will be described in detail with reference to FIG. 22. The state manager 53 shown in FIG. 4 acquires the communication state of the terminals that are managed by the terminal management DB 5003 (step S43-1). “Private Invite” (or “Invite”) that is contained in the start request information received by the transmitter/receiver 51 is specified as communication state change request information. The change request information “Private Invite” (or “Invite”) is previously determined as specific change request information by the change request information determination unit 61. Accordingly, the state manager 53 acquires the communication state of not only of the start requesting terminal (the terminal 10aa) but of the destination terminal (the terminal 10db). The state manager 53 searches the terminal management table (see FIG. 7) with the terminal ID “10aa” of the start requesting terminal (the terminal “10aa”) as a search key and acquires the communication state “None” of the start requesting terminal (the terminal “10aa”) that transmitted the start request information. Similarly, the communication state “None” of the destination terminal (the terminal 10db) is acquired.

The state manager 53 then acquires pre-change state information on the start requesting terminal and the destination terminal corresponding to the change request information “Private Invite” (or “Invite”) (step S43-2). In this case, the state manager 53 searches the state change management table (see FIG. 11) using, as search keys, the change request information “Private Invite” (or “Invite”) and the terminal information “start requesting terminal” and acquires pre-change state information “None” on the start requesting terminal. Similarly, the state manager 53 searches the state change management table (see FIG. 11) using, as search keys, the change request information “Private Invite” (or “Invite”) and the terminal information “destination terminal” and acquires pre-change state information “None” on the destination terminal.

The state manager 53 compares the acquired communication state and pre-change state information and determines whether they match (step S43-3). The state manager 53 compares the acquired communication state “None” of the start requesting terminal (the terminal 10aa) and the acquired pre-change state information “None” and determines whether they match. Similarly, the state manager 53 compares the acquired communication state of the destination terminal (the terminal 10db) and the acquired pre-change state information on the destination terminal and determines whether they match.

When it is determined that the communication state and pre-change state information on the start requesting terminal match at step S43-3 and the communication state and the pre-change state information on the destination terminal match (YES at step S43-3), the state manager 53 acquires the change information on the start requesting terminal and the destination terminal corresponding to the change request information “Private Invite” (or “Invite”) (step S43-4). In this case, the state manager 53 searches the state change management table (see FIG. 11) using, as search keys, the change request information “Private Invite” (or “Invite”) and the terminal information “start requesting terminal” and acquires the change information “Private Ringing” (or “Ringing”) on the destination terminal.

According to the terminal ID “10aa” of the start requesting terminal (10aa) and the terminal ID “10db” of the destination terminal (the terminal 10db), the state manager 53 changes the communication state field part of the record where the terminal ID “10aa” and the terminal ID “10db” are contained in the terminal management table (see FIG. 7) (step S43-5). In this case, the communication state field part of the record where the terminal ID “10aa” is contained in the terminal management table is changed to “Private Calling” according to the acquired change information on the start requesting terminal. Similarly, the communication state field part of the record where the terminal ID “10db” is contained is changed to “Private Ringing” (or “Ringing”) according to the acquired change information on the destination terminal.

When the start request information specifies the restriction information indicating a joining restriction, the state manager 53 registers the terminal joining authentication information (PIN code) in the terminal management table, i.e., in the field of the joining authentication information on the terminal ID “10aa” of the start requesting terminal (the terminal 10aa) and the terminal ID “10db” of the destination terminal (the terminal 10db) (step S43-7).

When it is determined that the communication state of the requesting terminal and pre-change state information on the requesting terminal do not match or when it is determined that the communication state and pre-change state information on the destination terminal do not match (NO at step S43-3), the state manager 53 does not change the communication state field part of the record where the terminal ID “10aa” and the terminal ID “10db” are contained in the terminal management table (see FIG. 7) because the start requesting terminal (the terminal 10aa) or the destination terminal (the terminal 10db) is in a state where it cannot start voice communications. The transmitter/receiver 51 creates a given error message and transmits the error message to the start requesting terminal (the terminal 10aa) in order to end the process (step S43-6). In the start requesting terminal, the error message is displayed on the display 120.

Here, reference is made to FIG. 18. A process performed after the communication state is changed at step S43-5 will be described. First, the session ID generator 56a generates a session ID “sel” for identifying a session (contents data session sed) for executing communications with the destination terminal that is requested by the start requesting terminal (the terminal 10aa) (step S44). When the session ID is generated, the session manager 57 stores the session ID “sel” in the volatile storage unit 5100.

The relay device selector 56 of the management system 50 selects a relay device 30 for relaying contents data in the contents data session between the start requesting terminal (the terminal 10aa) and the destination terminal (the terminal 10db) (step S45). The relay device extractor 56b extracts the relay device IDs (“111a” and “111d”) corresponding to the terminals (“10aa” and “10db”) by searching the relay device selection management table according to the terminal ID “10aa” of the start requesting terminal (the terminal 10aa) and the terminal ID “10db” of the destination terminal (the terminal 10db) that are contained in the start request information that is transmitted from the start requesting terminal (10aa).

If the extracted delay device IDs match, the relay device selector 56 refers the operation state of the extracted relay device IDs among the operation state of the relay devices 30 that are managed in the relay device management table (see FIG. 5). When the operation state of the relay device ID is “On-line”, the relay device selector 56 selects the extracted relay device as a relay device for relaying contents data. When the extracted relay device IDs do not match, or when the operation state of the relay device ID is “Off-line” as a result of the referring, the relay device 30e whose relay device ID is “111e” is selected as a relay device for relaying contents data. A case will be described below where the relay device 30e is selected by the relay device selector 56 in the first embodiment.

When the process for selecting a relay device 30 ends, the session manager 57 stores and manages the relay device ID “111e” of the selected relay device, the terminal ID “10aa” of the start requesting terminal (the terminal “10aa”), and the terminal ID “10db” of the destination terminal (the terminal 10db) in the field part of the relay device ID, the terminal ID of the start requesting terminal, and the terminal ID of the destination terminal of the record where the session ID “sel” is contained in the session management table (see FIG. 9) of the non-volatile storage unit 5000 (step S46).

The transmitter/receiver 51 shown in FIG. 4 transmits the session ID that is generated by the session ID generator 56a and relay device connection information that is used for connecting to the relay device 30e, which is selected by the relay device selector 56, to the start requesting terminal (the terminal 10aa) via the communication network 2 (step S47). The relay device connection information can contain the IP address of the relay device 30e, authentication information, port number etc. Accordingly, the terminal 10aa can know relay device connection information that is used to connect to the relay device 30e, which is used to relay contents data during execution of the session of the session ID “sel”.

The transmitter/receiver 51 transmits, to the destination terminal (the terminal 10db), the start request information containing the terminal ID “10aa” of the start requesting terminal (the terminal 10aa), “Private Invite”, and the session ID “sel”; the relay device connection information that is used to connect to the relay device 30e; and the IP address of the management system 50 (step S48). Accordingly, the transmitter/receiver 11 of the destination terminal (the terminal 10db) receives the start request information and know the relay device connection information, which is used to connect to the relay device 30e used to relay contents data, and the IP address “1.1.1.2” of the transmitting management system 50.

A process will be described with reference to FIGS. 23 and 22 where the user of the destination terminal (the terminal 10db) that has received the start request information touches the operation button 108 shown in FIG. 2 so that a response indicating a permission to start communications with the start requesting terminal (the terminal 10aa) (to establish a session) is accepted. FIG. 23 describes an example where restriction information indicating that there is a joining restriction is specified as start request information.

When the transmitting/receiving process shown in FIG. 23 starts, the display 120 of the destination terminal (the terminal 10db) displays a start request receiving screen that indicates that the start request information has been received (step S49-1). As shown in FIG. 24, a start request receiving screen 1300-1 indicates that start request information has been received. If the start request information contains restriction information indicating that there is a joining restriction, for example, “THIS IS JOINING-RESTRICTED CONFERENCE” indicating that there is a joining restriction is shown.

By browsing the start request receiving screen, the user can know that the start request has been received and can check whether the TV conference of the session for which a start requested has been made is a joining-restricted conference for which a joining restriction is specified.

The user of the destination terminal (the terminal 10db) operates the operation button 108 and thus the operational-entering accepting unit 12 accepts a response indicating a permission to start communications (to establish a session) with the start requesting terminal (the terminal 10aa) (step S49-2). The transmitter/receiver 11 of the destination terminal (the terminal 10db) then transmits, to the management system 50, start response information that contains the terminal ID “10db” of the destination terminal (the terminal 10db), the terminal ID “10aa” of the start requesting terminal (the terminal 10aa), the change request information “Private Accept” indicating a permission to establish a session with a joining restriction, and the session ID “sel” (step S50).

When the transmitter/receiver 51 of the management system 50 receives this start response information, the state manager 53 changes, according to the terminal ID “10aa” of the start requesting terminal (the terminal 10aa) and the terminal ID “10db” of the destination terminal (the terminal 10db), the communication state field part of the record where the terminal ID “10aa” and the terminal ID “10db” are contained in the terminal table (see FIG. 7) (step S51).

The process at step S51 will be described in detail below with reference to FIG. 22. First, when the transmitter/receiver 51 of the management system 50 receives the start response information, the state manager 53 acquires the communication state of the terminals that is managed in the terminal management table (see FIG. 7) as in the case of the process at step S43-1 (step S51-1). The change request information determination unit 61 determines that the change request information “Accept” that is received by the transmitter/receiver 51 is specific change request information. On the basis of the determination, the state manager 53 acquires not only the communication state “Ringing” or “Private Ringing” of the destination terminal (the terminal 10db) but also the communication state “Calling” or “Private Calling” of the start requesting terminal (the terminal 10aa).

As in the case of the process at step S43-2, the state manager 53 then acquires the pre-change state information “Private Calling” and “Private Accepted” on the start requesting terminal corresponding to the change request information “Private Accept” that is managed in the state change management table (see FIG. 11).

Similarly, the state manager 53 acquires the pre-change state information “Private Ringing” corresponding to the change request information “Private Accept” that is managed in the state change management table (see FIG. 11) (step S51-2).

The state manager 53 compares the acquired communication state and pre-change state information and determines whether they match (step S51-3). The state manager 53 determines whether the acquired communication state “Private Calling” of the start requesting terminal (the terminal 10aa) matches any one of the pre-change state information “Private Calling” and “Private Accepted” on the start requesting terminal. Similarly, the state manager 53 determines whether the acquired communication sate “Private Ringing” of the destination terminal (the terminal 10db) matches the pre-change state information “Private Ringing” on the destination terminal.

When the communication state of the start requesting terminal and pre-change state information on the start requesting terminal match and the communication state of the destination terminal and the pre-change state information on the destination terminal match (YES at step S51-3), the state manager 53 acquires change information on the start requesting terminal and the destination terminal corresponding to the response information “Private Accept” (step S51-4). The state manager 53 searches the state change management table (see FIG. 11) using, as search keys, the response information “Private Accept”, the terminal information “Start Requesting Terminal” indicating the start requesting terminal, and the pre-change state “Private Calling” indicating the pre-change communication state of the start requesting terminal, and acquires the change information “Private Accepted” of the start requesting terminal. Similarly, the state manager 53 searches the state change management table (see FIG. 11) using, as search keys, the response information “Private Accept”, the terminal information “Destination Terminal” indicating the destination terminal, and the pre-change state “Private Ringing” indicating the pre-change communication state of the destination terminal, and acquires the change information “Private Accepted” on the destination terminal.

According to the terminal ID “10aa” of the start requesting terminal (the terminal 10aa) and the terminal ID “10db” of the destination terminal (the terminal 10db), the state manager 53 changes the communication state field part of the record where the terminal ID “10aa” and the terminal ID “10db” are contained in the terminal management table (see FIG. 7) (step S51-5). According to the acquired change information on the start requesting terminal, the communication state field part of the record where the terminal ID “10aa” is contained in the terminal management table is changed to “Private Accepted”. Similarly, according to the acquired change information on the destination terminal, the communication state field part of the record where the terminal ID “10db” in the terminal management table is changed to “Private Accepted”.

When it is determined that the communication state of the start requesting terminal (10aa) and the pre-change state information on the start requesting terminal do not match or the communication state of the destination terminal (10db) and the pre-change state information on the destination terminal do not match (NO at step S51-3), the state manager 53 does not change the communication state field part of the record where the terminal ID “10aa” and the terminal ID “10db” are contained in the terminal management table (see FIG. 7). In this case, the transmitter/receiver 51 creates an error message and transmits the error message to the destination terminal (the terminal 10db), thus ending the process (step S51-6).

Here, reference is made to FIG. 23. A process performed after the communication state is changed at step S51-5 will be described. The transmitter/receiver 51 transmits, to the start requesting terminal (the terminal 10aa), start response information that contains the terminal ID “10db” of the destination terminal (the terminal 10db), the change request information “Private Accept” indicating acceptance of a request to start voice communications with the destination terminal, and the session ID “sel” (step S52). Upon receiving the start response information, the start requesting terminal (the terminal 10aa) transmits the session ID “sel” and the relay device connection information, which is acquired at step S47, to the relay device 30e via the transmitter/receiver 11, thereby connecting to the relay device 30e (step S53). In contrast, the destination terminal (the terminal 10db) transmits the session ID “sel” and the relay device connection information, which is acquired at step S48, to the relay device 30e via the transmitter/receiver 11, thereby connecting to the relay device 30e (step S54).

A process performed by the relay device 30e to start relaying contents data that is transferred between the start requesting terminal (the terminal 10aa) and the destination terminal (the terminal 10db) will be described with reference to FIG. 25. FIG. 25 shows the process for transmitting/receiving all various types of management information via the management information session sei.

First, the start requesting terminal (the terminal 10aa) is connected to the relay device 30e (see step S53) and then the transmitter/receiver 11 transmits, to the management system 50, relay request information that contains the terminal ID “10aa” of the start requesting terminal (the terminal 10aa), the session ID “sel”, and the change request information “Join” indicating a request to start the relay (step S71-1).

When the transmitter/receiver 51 of the management system 50 receives the relay request information, the state manager 53 changes, according to the terminal ID “10aa” of the start requesting terminal (the terminal 10aa) that is contained in the start request information, the communication state field part of the record where the terminal ID “10aa” is contained in the terminal management table (see FIG. 7) (step S72-1).

The process at step S72-1 will be described in detail with reference to FIG. 26. The start requesting terminal shown in FIG. 26 is referred to as a relay requesting terminal that transmits relay request information. The state manager 53 shown in FIG. 4 acquires the communication state of the terminals that is managed in the terminal management DB 5003 (step S72-1-1). In this case, the change request information determination unit 61 previously determines that the change request information “Join” that is received by the transmitter/receiver 51 is not specific change request information. Accordingly, the state manager 53 acquires only the communication state of the relay requesting terminal (the terminal 10aa). The state manager 53 searches the terminal management table (see FIG. 7) with the terminal ID “10aa” (the terminal 10aa) serving as a search key and acquires the communication state “Private Accepted” (or “Accepted”) of the relay requesting terminal (the terminal 10aa) that has made a relay stat request.

The state manager 53 then acquires pre-change state information corresponding to the change request information “Join” (step S72-1-2). The state manager 53 searches the state change management table (see FIG. 10) with the change request information “Join” serving as a search key and acquires the pre-change state information “Private Accepted” (or “Accepted”).

The state manager 53 compares the acquired communication state and pre-change state information and determines whether they match (step S72-1-3). The state manager 53 compares the acquired communication state “Private Accepted” (or “Accepted”) of the relay requesting terminal (the terminal 10aa) and the pre-change state information “Private Accepted” (or “Accepted”) that is acquired by the state manager 53 and determines whether they match.

When it is determined that the communication state of the relay requesting terminal and the pre-change state information on the relay requesting terminal match (YES at step S72-1-3), the state manager 53 acquires change information corresponding to the change request information “Join” (step S72-1-4). The state manager 53 searches the state change management table (see FIG. 10) with the change request information “Join” serving as a search key and acquire the change information “Private Busy” (or “Busy”).

According to the terminal ID “10aa” of the start requesting terminal (“10aa”), the state manager 53 changes the communication state field part of the record where the terminal ID “10aa” is contained in the terminal management table (see FIG. 7) (step S72-1-5). According to the acquired change information, the communication state field part of the record where the terminal ID “10aa” is contained in the terminal management table is changed to “Private Busy” (or “Busy”).

When the communication state of the requesting terminal and the pre-change state information on the requesting terminal do not match (NO at step S72-1-3), the state manager 53 does not change the communication state field part of the record where the terminal ID “10aa” is contained in the terminal management table (see FIG. 7). In this case, the transmitter/receiver 51 transmits an error message to the start requesting terminal (the terminal 10aa), thus ending the process (step S72-1-6).

Here, reference is made to FIG. 25. A process performed after the communication state is changed at step S72-1-5 will be described. The management system 50 transmits, to the relay device 30e, relay start request information that contains the terminal ID “10aa” of the relay requesting terminal (the terminal 10aa) and the session ID “sel” (step S73-1). Upon receiving the relay start request information, the relay device 30e transmits, to the management system 50, relay start permission information that contains notice information “OK” indicating a permission to start the relay (step S74-1). Upon receiving this response, the transmitter/receiver 51 of the management system 50 transmits relay start permission information to the relay requesting terminal (the terminal 10aa) (step S75-1). Accordingly, the contents data session sed between the relay requesting terminal (the terminal 10aa) and the relay device 30e is established (step S76-1).

In contrast, at a given timing after the destination terminal (the terminal 10db) connects to the relay device 30e (see step S54 in FIG. 23), the transmitter/receiver 11 transmits, to the management system 50, relay request information that contains the terminal ID “10db” of the destination terminal (the terminal 10db), the session ID “sel”, and the change request information “Join” indicating a request to start the relay (step S71-2).

The management system 50 and the relay device 30e perform the same processes as those at steps S72-1, S73-1, S74-1, and S75-1 so that the contents data session sed between the destination terminal (the terminal 10db) and the relay device 30e (steps S72-2, S73-2, S74-2, S75-2, and S76-2). At step S72-2, the destination terminal is regarded as a terminal that transmits relay request information, i.e., as a relay requesting terminal. When the contents data session between the relay requesting terminal (the terminal 10aa) and the relay device 30e and the contents data session sed between the destination terminal (the terminal 10db) and the relay device 30e are established, the relay device 30e can relay three types of image data, i.e., low-resolution, medium-resolution, and high-resolution image data, as well as audio data between the terminals (10aa and 10db). Accordingly, the terminals (10aa and 10db) can start a TV conference.

A process will be described with reference to FIG. 27 where, after the contents data session is established between the start requesting terminal (the terminal 10aa) and the destination terminal (the terminal 10db), the terminal 10cd transmits joining request information of a request to join the contents data session. The terminal 10cd operates as a joining requesting terminal that transmits joining request information. FIG. 27 shows the process for transmitting/receiving all various types of management information via a management information session sei.

When the user wants to join a running session, which is a session that has been already established, to join a TV conference that uses this session, the user causes the terminal used by the user (here, the terminal 10cd) to display a destination list on a display 120cd of the terminal 10cd by performing the login process is described above with reference to FIG. 16 (step S101).

As shown in FIG. 28, a destination list 1400 displaying a list of destination terminals with each of which the terminal 10cd serving as a start requesting terminal can establish a session is displayed on the display 120cd of the terminal 10cd.

The user of the joining requesting terminal (the terminal 10cd) operates the operation button 108 shown in FIG. 2 to select a terminal that is already joining a session that the user wants to join (hereinafter, joining terminal) from the destination list 1400. The operational-entering accepting unit 12 thus accepts a request to join the running contents data session (step S104). A case is described below where the terminal 10db serving as a joining terminal is elected.

The transmitter/receiver 11 of the joining requesting terminal (the terminal 10cd) that makes a joining request transmits, to the management system 50, joining request information that contains the terminal ID “10cd” of the joining requesting terminal, change request information “Call” indicating a request to join the contents data session, and the terminal ID “10db” of the selected joining terminal (step S105).

Upon receiving the session joining request information, the management system 50 uses the destination list management table (FIG. 8) to determine whether to continue the process for connecting the joining requesting terminal (the terminal 10cd) and the joining terminals (the terminals 10aa and 10db) that are joining the contents data session sed (step S106). Here, the process at step S106 will be described in detail with reference to FIG. 29. FIG. 29 is a flowchart of a procedure for joining determination based on the communication state.

The state manager 53 refers to the terminal management table (FIG. 7) and acquires the communication state of the joining terminal (the terminal 10db) with the terminal ID “10db” of the selected joining terminal (the terminal 10db) serving as a search key (step S106-1). The joining determination unit 63 then refers to the acquired communication state. When the acquired communication state is “Busy” (Busy at step S106-2), the joining determination unit 63 permits the joining requesting terminal to join the running session (step S106-3).

When the acquired communication state is “Private Busy” (Private Busy at step S106-2), the joining determination unit 63 acquires an upper limit from the terminal management DB 5003 (step S106-4). The transmitter/receiver 51 then makes a joining authentication information inquiry to the joining requesting terminal (the terminal cd) (step S106-5). The display controller 16 of the joining requesting terminal displays the joining authentication information entering screen on the display 120cd to accept joining authentication information to be entered by the user (step S106-6, see FIG. 27). The transmitter/receiver 11 of the joining requesting terminal transmits the accepted joining authentication information to the management system 50 and the transmitter/receiver 51 of the management system 50 receives the joining authentication information (step S106-7).

The joining determination unit 63 of the management system 50 compares the contents of the joining authentication information that is received from the joining requesting terminal and the contents of the joining authentication information that is registered in association with each of the terminal IDs of the joining terminals (the terminals 10aa and 10db) and determines whether they match (step S106-8).

When they match (YES at step S106-8), the joining determination unit 63 permits the joining requesting terminal to join the running session (step S106-3).

In contrast, when they do not match (NO at step S106-8), the joining determination unit 63 does not allow the joining requesting terminal to join the running session and counts up by 1 the mismatch counter of the terminal management DB 5003 and determine whether the number of times they do not match, i.e., the number of mismatching, reaches the upper limit that is acquired at step S106-4 (step S106-9). The joining determination unit 63 stores the fact of mismatching between the joining authentication information in the terminal management DB 5003.

When the number of times of mismatching does not reach the upper limit (NO at step S106-9), step A106-5 is repeated where the transmitter/receiver 51 makes a joining authentication information inquiry to the joining requesting terminal (the terminal cd) (step S106-6). Accordingly, the display controller 16 of the joining requesting terminal displays the joining authentication information re-entering screen on the display 120cd. FIG. 30 is a diagram of the joining authentication information re-entering screen.

The user of the joining requesting terminal re-enters the joining authentication information (PIN code) and touches the OK button via the joining authentication information re-entering screen. The transmitter/receiver 51 of the management system 50 thus receives the re-entered joining authentication information (step S106-7, see FIG. 27). The joining determination unit 63 compares again whether the contents of the joining authentication information, which is received from the joining requesting terminal, and the contents of the joining authentication information that is registered in association with each of the terminal IDs of the joining terminals (the terminals 10aa and 10db) in the terminal management table, and determines whether they match (step S106-8).

The processes at steps S106-5, S106-6, S106-7, and S106-8 are repeatedly performed until the number of times of mismatching reaches the upper limit even when the joining authentication information entered from the joining requesting terminal is wrong. In other words, the user of the joining requesting terminal can re-enter joining authentication information until the number of times of mismatching reaches the upper limit.

When the number of times of mismatching reaches the upper limit (YES at step S106-9), the joining determination unit 63 prohibits the joining requesting terminal from joining the running session (step S106-10).

The transmitter/receiver 51 then transmits a message indicating that there is a terminal that has failed to join the session to all terminals (the terminals 10aa and 10db in the example shown in FIG. 27) that are joining the running session (step S106-11). Upon receiving the message, the terminals (the terminals 10aa and 10db) display the message on their displays 120. FIG. 31 is a diagram of an example of display of the message on the display 120 of the terminal 10aa that is joining the session. As shown in FIG. 31, the message “JOINING REQUEST MADE BY VOICE COMMUNICATION TERMINAL 10cd” and the OK button are displayed on the display 120 of the terminal 10aa.

In the example shown in FIG. 31, only the terminal name of the terminal that is rejected to join the session is displayed. Alternatively, the display controller 11 of the terminal 10 may be configured to display the terminal ID to show which terminal makes a request even if the terminal name is not previously registered in the terminal 10aa.

In the first embodiment, the message indicating that there is a terminal that has failed to join a session is sent to all terminals that are joining the session. Alternatively, the joining determination unit 63 of the management system 50 may be configured to transmit the message to only the terminal 10aa that input the joining authentication information when the session was started.

The transmitter/receiver 51 further transmits, to the joining requesting terminal (the terminal 10cd), an error message for notifying that the terminal cannot join the session (step S106-12) and ends the process. When the joining requesting terminal (the terminal 10cd) receives the error message, it displays the error message on the display 120.

Here, reference is made to FIG. 27. A process will be described below that is performed after the joining requesting terminal (the terminal 10cd) is permitted to join the running session and a process for connecting the joining requesting terminal to the joining terminals (the terminals 10aa and 10db) is continued.

According to the terminal ID “10cd” of the joining requesting terminal (the terminal 10cd) that is contained in the joining request information, the state manager 53 of the management system 50 changes the communication state field part of the record where the terminal ID “10cd” is contained in the terminal management table (see FIG. 7) (step S107).

The process at step S107 will be described in detail below with reference to FIG. 32. The state manager 53 shown in FIG. 4 acquires the communication state of the joining requesting terminal that is managed in the terminal management DB (step S107-1). In this case, the change request information determination unit 61 previously determines that the change request information “Call” that is received by the transmitter/receiver 51 is not specific change request information. According to the determination, the state manager 53 acquires only the communication state of the joining requesting terminal (the terminal 10cd). In this case, the state manager 53 searches the terminal management table (see FIG. 7) with the terminal ID “10cd” of the joining requesting terminal (the terminal 10cd) serving as a search key and acquires the communication state “None” of the joining requesting terminal (the terminal 10cd).

The state manager 53 then acquires pre-change state information on the destination terminal corresponding to the change request information “Call” (step S107-2). In this case, the state manager 53 searches the state management table (see FIG. 10) with the change request information “Call” serving as a search key and acquires the pre-change state information “None”.

The state manager 53 then compares the acquired communication state of the joining requesting terminal and the pre-change state information on the joining requesting terminal and determines whether they match (step S107-3). In this case, the state manager 53 compares the communication state “None” of the joining requesting terminal (the terminal 10cd) and the pre-change state information “None” on the joining requesting terminal and determines whether they match.

When it is determined that the communication state of the joining requesting terminal and the pre-change state information on the joining requesting terminal match (YES at step S107-3), the state manager 53 acquires change information corresponding to the change request information “Call” (step S107-4). In this case, the state manager 53 searches the state change management table (see FIG. 1) with the change request information “None” serving as a search key and acquires change information “Accepted”.

According to the terminal ID “10cd” of the joining requesting terminal (the terminal 10cd), the state manager 53 changes the communication state field part of the record where the terminal ID “10cd” is contained in the terminal management table (see FIG. 7) (step S107-5). In this case, according to the acquired change information, the field part of the communication state of the record where the terminal ID “10cd” in the terminal management table is changed to “Accepted”.

When it is determined that the communication state of the joining requesting terminal and the pre-change state information on the joining requesting terminal do not match (NO at step S107-3), the state manager 53 does not change the communication state field part of the record where the terminal ID “10cd” is contained in the terminal management table (see FIG. 11). In this case, the transmitter/receiver 51 transmits an error message to the joining requesting terminal (the terminal 10cd), thus ending the process (step S107-6).

Here, reference is made to FIG. 27. A process performed after the communication state is changed at step S107-5 will be described. The session manager 57 adds the terminal ID “10cd” of the joining requesting terminal (the terminal 10cd) to the destination terminal field part of the record where the session ID “sel” is contained in the session management table (see FIG. 9) of the non-volatile storage unit 5000 (step S108).

When the joining requesting terminal is permitted to join the running session (the contents data session sed) at step S106-3 shown in FIG. 29, the transmitter/receiver 51 of the management system 50 transmits, to the joining requesting terminal (the terminal 10cd), the session ID “sel” and a joining permission notice that contains and relay device connection information that is used to connect to the relay device 30e (step S109).

When the terminal 10cd receives the joining permission notice, the transmitter/receiver 11 transmits the session ID “sel” and the relay device connection information, which is contained in the joining permission notice, to the relay device 30e to connect to the relay device 30e (step S110). Furthermore, at a given timing after the joining terminal (the terminal 10cd) is connected to the relay device 30e, the transmitter/receiver 11 transmits, to the management system 50, relay request information that contains the terminal ID “10cd” of the terminal 10cd, the session ID “sel”, and the change request information “Join” indicating a relay start request. Subsequently, the management system 50 and the relay device 30e perform the same processes as steps S72-1, S73-1, S74-1, and S75-1 so that a contents data session sed between the terminal 10cd and the relay device 30e is established. Once the contents data sessions sed is established, the relay device 30e can relay three types of image data, i.e., low-resolution, medium-resolution, and high-resolution image data, as well as audio data between the terminals (10aa, 10cd, and 10db). Accordingly, the terminals (10aa, 10cd, and 10db) can start a TV conference.

The transmitter/receiver 51 of the management system 50 transmits a joining notice that contains the terminal ID of the joining requesting terminal (the terminal 10cd) and the session ID “sel” to the joining terminals (the terminals 10aa and 10db) that have already started the contents data session sed (steps S111-1 and S111-2). Accordingly, the joining terminals (the terminals 10aa and 10db) can know that the joining requesting terminal (the terminal 10cd) joins the contents data session.

The terminal extractor 54 searches the destination list management table (see FIG. 8) using, as a search key, the terminal ID of the joining requesting terminal (the terminal 10cd) that is contained in the session joining request information and reads the terminal IDs of the destination terminals corresponding to the joining requesting terminal, thereby extracting the terminal IDs “10aa, 10dd, and 10db” (step S112). The transmitter/receiver 51 of the management system 50 transmits a joining notice (an example of joining information) that contains the terminal ID “10cd” to the terminal 10bb to which the joining notice has not been transmitted among the terminals (10aa, 10bb, and 10db) that are identified by the extracted terminal IDs (step S113). Accordingly, the terminal ID 10bb can know that the joining requesting terminal (the terminal 10cd) joins the contents data session.

<<Main Effects of Embodiment>>

As described above, according to the first embodiment, when a session for transferring contents data between a first terminal (the terminal 10aa) and a second terminal (the terminal 10db) has been established, the transmitter/receiver 51 of the management system 50 accepts a request to join the session from a third terminal (the terminal 10cd). When the first terminal (the terminal 10aa) starts a session with a joining restriction with the second terminal (the terminal 10db), the management system 50 registers joining authentication information that is entered from the first terminal. When the running session is a session with a joining restriction, the joining determination unit 63 of the management system 50 causes the third terminal to enter joining authorization information. When the joining authentication information from the first terminal and the joining authentication information from the third terminal match or the session have no joining restriction, the joining determination unit 63 of the management system 50 allows the third terminal to join the session. Accordingly, while simply and appropriately restricting middle-way joining in a session that is used for a conference etc. where highly-confidential information is communicated, the management system 50 of the first embodiment permits the third terminal that knows the joining authentication information to join the session middle-way, which improves the security and consults the convenience of the user.

Furthermore, in the first embodiment, even if the entered joining authentication information and the authentication information that is registered before the session is started do not match, the third terminal is not immediately prohibited from joining the session and the user of the joining requesting terminal is let re-enter joining authentication information until the number of mismatching reaches the upper limit. Accordingly, it is not necessary to re-select a terminal for a session to which a joining request is made from the destination list after the joining requesting terminal is immediately prohibited from joining the session and thus the security is maintained while a joining request can be performed again easily, which is convenient for the user.

The management system 50 performs control to connect the first terminal (10aa), the second terminal (10db), and the third terminal (10cd). The transmitter/receiver 51 transmits, to the third terminal, relay device connection information for connecting to the relay device 30e that relays the contents data, which is transmitted from the first terminal, to the second terminal. Accordingly, the third terminal can connect to the relay device 30e by using the relay device connection information.

In the first embodiment, the number of times of mismatching of joining authentication information is used as a condition for joining rejection. However, the condition is not limited to this. For example, the joining determination unit 63 may be configured such that a condition for the period, the condition on whether mismatching is successive, etc. may be added to conditions for joining rejection. For example, the joining determination unit 63 and the transmitter/receiver 51 may be configured such that, when one hour is set to the period and, if it is determined that authentication information that is successively entered by the terminal 10ac to the upper limit within one hour mismatch, the terminal 10aa that is running the session is notified. In this case, the joining determination unit 63 may be configured such that the management system 50 does not accept the terminal 10ac to join the session until one hour that is set for the period elapses.

### Second Embodiment

In the first embodiment, joining is prohibited when a joining requesting terminal re-enters joining authentication information and accordingly the number of times of mismatching reaches the upper limit. However, if the joining requesting terminal selects a terminal from the destination list again and makes a joining request, joining authentication information can be entered. In the second embodiment, when the number of times mismatching of joining authentication information reaches an upper limit and thus a joining requesting terminal is rejected to join a running session, the joining requesting terminal is registered in the terminal management DB as a joining-rejected terminal and, when the joining requesting terminal makes a joining request again, it is rejected to join the following sessions without determination on matching of joining authentication information.

The network configuration of the transfer system 1 of the second embodiment; the hardware configurations of the terminal 10, the management system 50, the relay device 30, and the program providing system 90 or the maintenance system 100; and functional configurations of each terminal, each device, and each system that configure the transfer system 1 are the same as those of the first embodiment.

When the number of times joining authentication information from a joining requesting terminal and joining authentication information that is registered in a terminal management table do not match reaches an the upper limit and the joining requesting terminal is rejected to join a running session, the joining determination unit 63 of the management system 50 of the second embodiment registers, in the terminal management table, the terminal ID of the joining requesting terminal as a joining-rejected terminal in association with the terminal IDs of terminals in the running session.

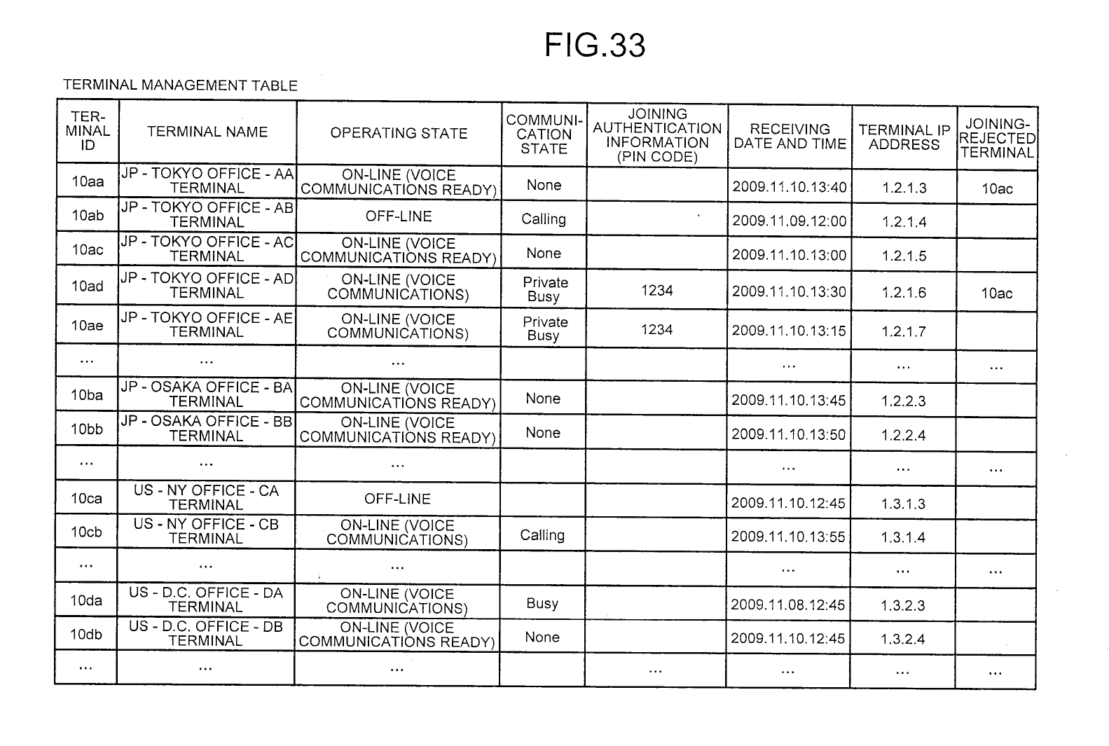

FIG. 33 is a diagram of an example of a terminal management table according to the second embodiment. As shown in FIG. 33, the terminal management table has a joining-rejected terminal field where the terminal IDs of joining-rejected terminals are registered in association with the terminal IDs of terminals that is joining sessions.

When the joining request information is a request to join a running session that is established according to start request information that specifies a joining restriction, the joining determination unit 63 determines whether the terminal ID of a terminal that has transmitted the joining request information is registered as a joining-rejected terminal corresponding to the terminal ID of the terminal that is joining the running session. When the terminal is registered as a joining-rejected terminal, the joining determination unit 63 rejects the terminal to join the running session without requesting the joining requesting terminal for joining authentication information and making determination on matching of joining authentication information.

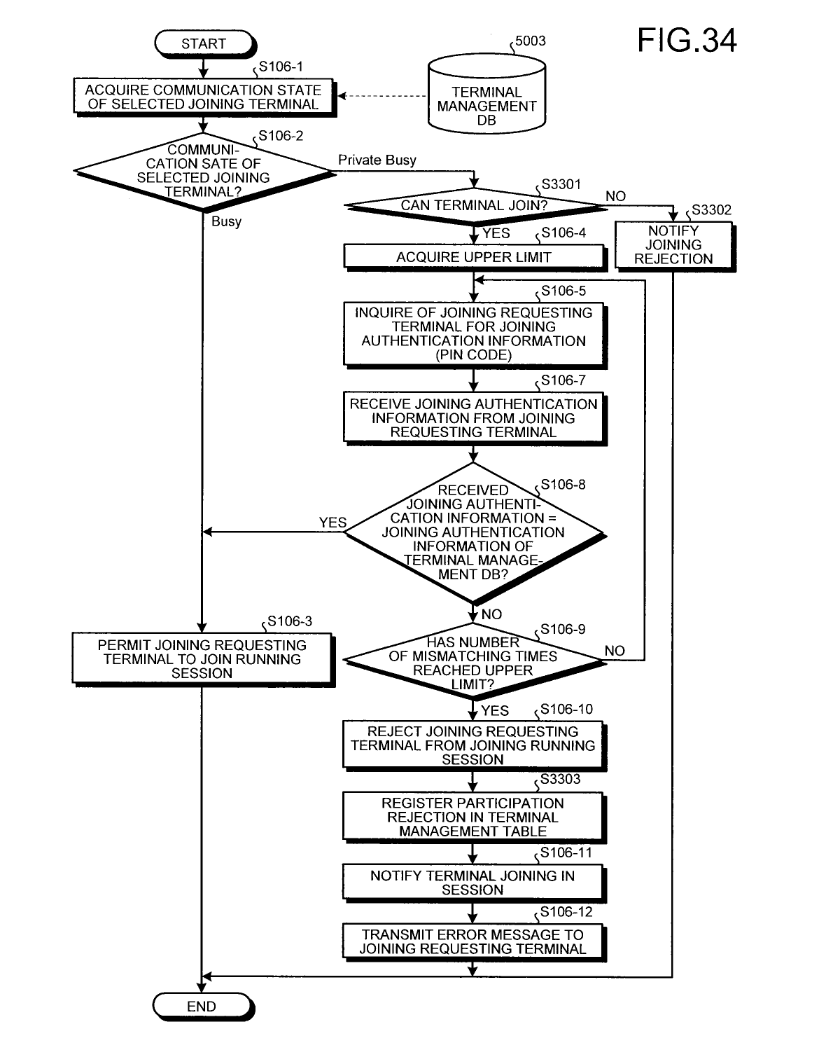

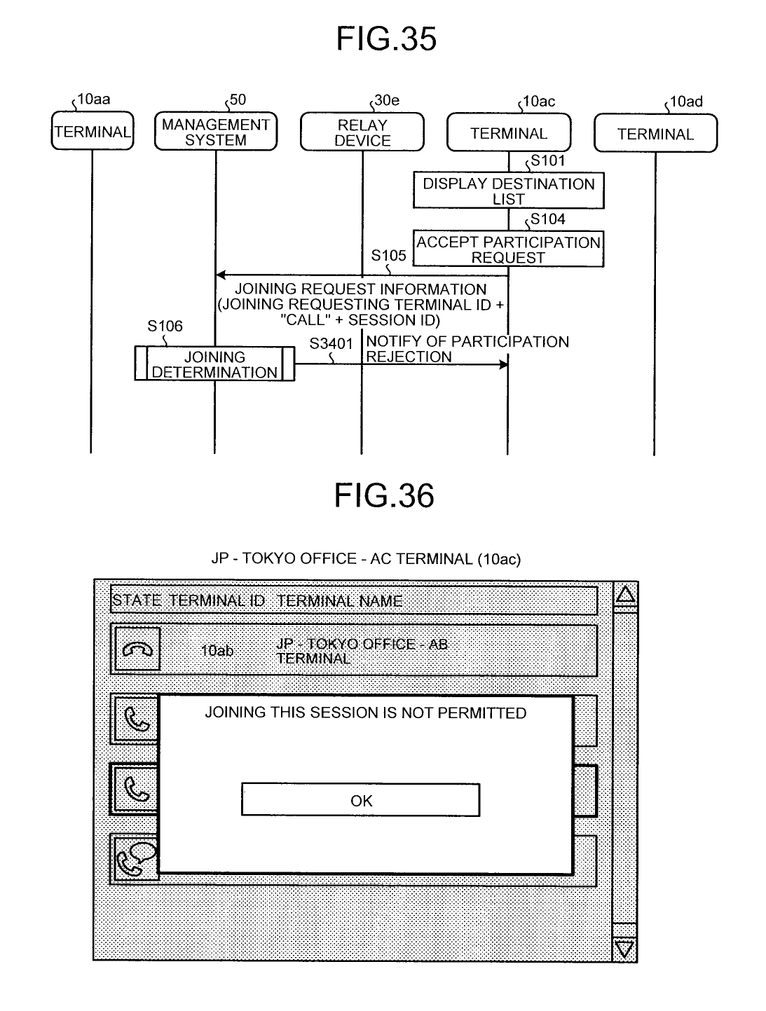

FIG. 34 is a flowchart of a procedure for joining determination according to the second embodiment. FIG. 35 is a sequence chart of a process for transmitting information of a request to join a contents data session according to the second embodiment.

As shown in FIG. 35, as in the case of the first embodiment, a joining requesting terminal (the terminal 10ac) displays a destination list (step S101), a terminal in a running session is selected from the destination list and a joining request is accepted (step S104) and joining request information is transmitted from the joining requesting terminal to the management system 50 (step S105). The joining determination unit 63 of the management system 50 that has received the joining request information performs a joining determination process (step S106).

In the joining determination process of the second embodiment shown in FIG. 34, steps S106-1, S106-2, and S106-3 are the same as those of the first embodiment.

When the communication state that is acquired at step S106-1 is “Private Busy” (Private Busy at step S106-2), the joining determination unit 63 refers to the terminal management table and determines whether the terminal ID of the joining requesting terminal (the terminal 10ac in the example shown in FIG. 35) that has transmitted the joining request information is registered as a joining-rejected terminal with respect to the terminals (the terminals 10aa and 10ad in the example shown in FIG. 35) in the running session, thereby determining whether the joining requesting terminal is a terminal that can join the running session (step S3301).

When the terminal ID of the joining requesting terminal is registered as a joining-rejected terminal with respect to the terminals in the running session and the joining requesting terminal is not a terminal that can join the running session (NO at step S3301), the joining determination unit 63 notifies the joining requesting terminal of a joining rejection (steps S3302 and S3401) and ends the process. Accordingly, inquiry and reception of joining authentication information to and from the joining requesting terminal (steps S106-5 and S106-7) and determination on matching of joining authentication information (step S106-8) are not performed.

FIG. 36 is a diagram of an example of a joining rejection notice that is displayed on the display 120 of the joining requesting terminal. The fact that joining is rejected is displayed by, for example, “JOINING THIS SESSION IS NOT PERMITTED” on the display of the joining requesting terminal as shown in FIG. 36. The terminal that has received a joining rejection message cannot join this session until its registration as a joining-rejected terminal is cancelled in the terminal management table of the management system 50.

The joining determination unit 63 and the session manager 57 may be configured such that, even if a terminal is registered as a joining-rejected terminal in the terminal management table, the registration of the terminal as a joining-rejected terminal in the terminal management table is canceled (deleted) when a given time elapses or when the session ends.

When the terminal ID of the joining requesting terminal is not registered in the terminal management table as a joining-rejected terminal with respect to the terminals that are joining the running session and the joining requesting terminal is a terminal that can join the running session (YES at step S3301), the joining determination unit 63, as in the case of the first embodiment, acquires the upper limit (step S106-4), performs an inquiry and reception of joining authentication information to and from the joining requesting terminal (steps S106-5 and S106-7), makes determination on matching of joining authentication information (step S106-8), and determines whether the upper limit of the number of times of mismatching reaches the upper limit (step S106-9).

When the number of times of mismatching does not reach the upper limit (NO at step S106-9), the steps S106-5 to S106-8 are repeated as in the case of the first embodiment.

When the number of times of mismatching reaches the upper limit (YES at step S106-9), the joining determination unit 63 prohibits the joining requesting terminal from joining the running session (step S106-10).

The joining determination unit 63 then registers the terminal ID of the joining requesting terminal (the terminal 10ac) as a joining-rejected terminal in association with the terminal IDs of the terminals (the terminals 10aa and 10ad) in the running session in the terminal management table (step S3303).

As in the case of the first embodiment, the transmitter/receiver 51 notifies all the terminals (the terminals 10aa and 10ad in the example shown in FIG. 35) that are joining the running session of a message indicating that there is a terminal that failed to join the running session (step S106-11) and transmits, to the joining requesting terminal (the terminal 10ac), an error message for notifying that the terminal cannot join the session (step S106-12) and ends the joining determination process.

According to the second embodiment, as described above, when the number of times of mismatching of joining authentication information reaches the upper limit and the joining requesting terminal is rejected to join the running session, the joining requesting terminal is registered as a joining-rejected terminal in the terminal management table and, when a joining request is made again, the terminal is rejected to join the following sessions without determination on matching of joining authentication information, which improves the security.

The embodiments are described above and various changes or modifications may be made for the embodiments described above.

As one modification, the display controller 16 of the terminal 10 may be configured such that a software keyboard is displayed on the joining authentication information entering screen so that joining authentication information can be entered via the software keyboard.

The display controller 16 and the operational-entering accepting unit 12 may be configured such that a screen for hand-writing entering, etc. is displayed on the joining authentication information entering screen so that joining authentication information can be entered by handwriting, and the terminal 10 may be configured to include a sensing unit that senses entered letters.

In the first embodiment, when a session with a joining restriction is started, a start requesting terminal voluntarily enters joining authentication information before the start requesting terminal transmits start request information to the management system 50. Alternatively, for example, the management system 50 and the terminal 10 may be configured such that, when a start requesting terminal transmits start request information to the management system 50, the management system 50 requests the start requesting terminal to enter joining authentication information and the start requesting terminal enters joining authentication information and the management system 50 registers the joining authentication information.

In the above-described embodiments, destination terminals do not enter joining authentication information when a session is started. Alternatively, for example, the management system 50 and the terminal 10 may be configured such that, when a session is started, a destination terminal is caused to enter joining authentication information and a start requesting terminal makes determination on matching of the joining authentication information with joining authentication information that is entered by a start requesting terminal.

In the above-described embodiments, joining restriction information is not displayed on a destination list that is displayed on a joining requesting terminal. Alternatively, the management system 50 and the terminal 10 may be configured such that joining restriction information is displayed on a destination list that is displayed on a joining requesting terminal and joining authentication information is entered when a terminal with a joining restriction is selected.

In the above-described embodiments, joining authentication information is registered and managed in association with terminals 10 in a terminal management table. Alternatively, the management system 50 may be configured such that it manages joining authentication information for each session.

<<Supplementary Notes for Embodiments>>

The management system 50 and the program providing system 90 of each of the above-described embodiments may be developed by using a single computer, or the units (functions or means) of the management system 50 and the program providing system 90 may be divided and the divided parts may be developed by arbitrarily-allocated multiple computers. If the program providing system 90 is developed by using a single computer, the programs that are transmitted by the program providing system 90 may be transmitted as multiple modules or an single module. If the program providing system 90 is developed by using multiple computers, multiple separate modules may be transmitted from the computers, respectively.

The recording medium that stores the terminal program, the relay device program, and the transfer management program, the HD 204 that stores these programs, and the program providing system 90 that includes the HD 204 are used as a program product to provide domestically or abroad the terminal program, the relay device program, and the transfer management program to the user etc.

In the above-described embodiments, image data is managed in the quality change management table and the quality management table by focusing on the image resolution of image data, which is relayed by the relay device 30, as an example of the image quality of the image data. Alternatively, the depth of the image quality of image data, the sampling frequency in audio of the audio data, and the bit length of audio of the audio data may be focused on and managed as an example of the quality.

The receiving data and time is managed in the terminal management table shown in FIG. 7 and the session management table shown in FIG. 9. Alternatively, at least the receiving time of the receiving date and time may be managed.

In the above-described embodiments, the IP addresses are managed in the relay device management table shown in FIG. 5, the IP addresses of terminals are managed in the terminal management table shown in FIG. 7. Alternatively, if relay device specifying information for specifying a relay device 30 in the communication network 2 and terminal specifying information for specifying terminals 10 in the communication network 2 are used, each FQDN (Fully Qualified Domain Name) may be managed. In this case, a known DNS (Domain Name System) server acquires an IP address corresponding to the FQDN. Note that the information may be expressed not only as “relay device specifying information for specifying a relay device 30 in the communication network 2” but also as “relay device connection destination information indicating a connection destination to the relay device 30 on the communication network 2” or “relay device destination information indicating a destination to the relay device 30 on the network 2”. Similarly, the information may be expressed not only as “terminal specifying information for specifying a terminal 10 in the communication network 2” but also as “terminal connection destination information indicating a connection destination to a terminal 10 in the communication network 2” or “terminal destination information indicating a destination to the terminal 10 on the communication network 2”.

In the above-described embodiments, “TV conference” is used as a word that can be replaced by “videoconference”.

In the above-described embodiments, a TV conference system is described as an example of the transfer system 1. Alternatively, the transfer system 1 may be a telephone system using IP (Internet Protocol) phone or Internet phone. Alternatively, the transfer system 1 may be a car navigation system. In this case, for example, a terminal 10 serves as a car navigation device that is installed in a car and another terminal 10 serves as a management terminal or a management server of a management center that manages the car navigation, or serves as a car navigation device that is installed in another car. The transfer system 1 may be an audio conference system or a PC (Personal Computer) screen sharing system.

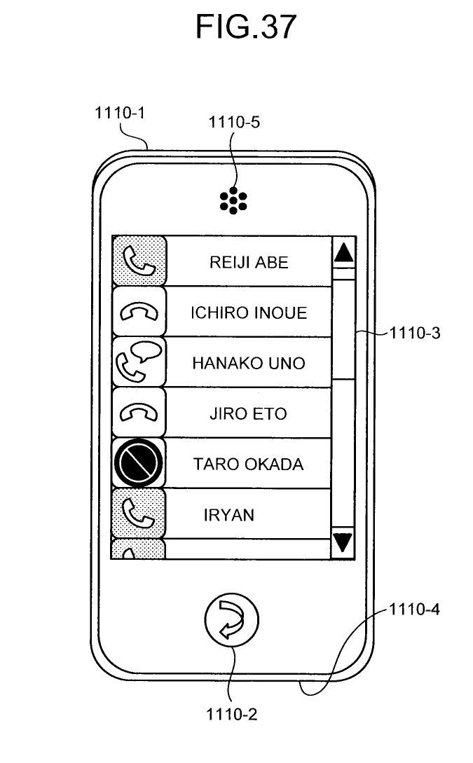

The transfer system 1 may be a mobile-phone communication system. In this case, for example, a terminal 10 serves as a mobile phone. In this case, the display example of the destination list is shown in FIG. 37. FIG. 37 is a schematic diagram of a destination list according to another embodiment. A terminal 10 that serves as a mobile phone includes a main unit 1110-1 of the mobile phone, a menu screen display button 1110-2 that is provided to the main unit 1110-1, a display unit 1110-3 that is provided to the main unit 1110-1, a microphone 1110-4 that is provided in a lower part of the main unit 1110-1, and a speaker 1110-5 that is provided to the main unit 1110-1. The “menu screen display button” 1110-2 is a button for displaying a menu screen on which icons showing various applications are displayed. The display unit 1110-3 is a touch panel with which the user can select a destination name in order to make voice communications with a peer mobile phone.

In the above-described embodiments, image data and audio data are described as examples of the contents data. Alternatively, contents data may be touch data. In this case, touching feeling of the user of one terminal is communicated to another terminal. Furthermore, the contents data may be smell data. In this case, odor (smell) at one terminal is communicated to another terminal. The contents data may be at least one of image data, audio data, touch data, and smell data.

In the above-described embodiments, the transfer system 1 is used to carry out a TV conference. Alternatively, the transfer system 1 may be used for general conversations between family members or friends or for providing unidirectional information.

According to an aspect of the invention, there is an effect that members are restricted and specific members are permitted to join more simply and appropriately, which improves the security and is beneficial to users.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A communication system comprising:
a first acquiring unit configured to obtain start request information for requesting start of a session between a first terminal and a second terminal and the start request information including information for specifying whether participation in the session of a terminal other than the first terminal and the second terminal is limited or not, and participation authentication information for authenticating participation in the session for the terminal when the participation of the terminal in the session is limited;
a session manager configured to establish the session between the first terminal and the second terminal according to the start request information;
a second acquiring unit configured to obtain participation request information for requesting participation of a third terminal in the session, and the participation authentication information input from the third terminal; and
a participation determination unit configured to, when the participation request information consists of a participation request in the session in which the participation of the terminal is limited, compere the participation authentication obtained by the first acquiring unit and participation authentication information obtained by the second acquiring unit, and determine whether participation of the third terminal in the session is allowed or not according to a result of comparison, and the participation determination unit configured, if the participation of the third terminal in the session is not allowed, to record terminal information of the third terminal, and to reject a subsequent participation request of the third terminal in the session thereafter on the basis of the recorded terminal information.

2. The communication system set forth in claim 1, wherein the participation determination unit rejects the participation of the third terminal in the session when the number of discrepancies between the participation authentication information that is obtained by the first acquiring unit and the participation authentication information that is obtained by the second acquiring unit reaches a predetermined upper limit value.

3. The communication system set forth in claim 2 further comprising a giving notice unit configured, when the participation of the third terminal to the session is rejected, to transmit a message to the third terminal indicating that the participation is rejected.

4. The communication system set forth in claim 3, wherein, the giving notice unit further transmits a message indicating that there is a terminal failing to participate in the session when the third terminal is rejected to participate in the session.

5. The communication system set forth in claim 2 further comprising a storage unit configured to store terminal management information in which terminal identification information for identifying the terminal are associated with the rejected terminal indicating the terminal identification information of the terminal being rejected to participate in the session,
wherein, when the participation determination unit rejects the third terminal to participate in the session, the participation determination unit records the terminal identification information of the third terminal in the rejected terminal corresponding to the terminal identification information of the first terminal and the terminal identification information of the second terminal in the terminal management information.

6. The communication system set forth in claim 5, wherein
when the participation request information consists of a request to participate in the session established by the start request information specifying the participation limitation, the participation determination unit determines whether the terminal identification information of the terminal transmitting the participation request information is recorded or not in the rejected terminal corresponding to the terminal identification information of the first terminal and the terminal identification information of the second terminal, and
if recorded, the participation determination unit rejects the terminal to participate in the session.

7. The communication system set forth in claim 1, wherein the participation determination unit requests participation authentication information of the third terminal.

8. A method for performing a communication system, the communication system comprising:
a first acquiring unit configured to obtain start request information for requesting start of a session between a first terminal and a second terminal and the start request information including information for specifying whether participation in the session of a terminal other than the first terminal and the second terminal is limited or not, and participation authentication information for authenticating participation in the session for the terminal when the participation of the terminal in the session is limited;
a session manager configured to establish the session between the first terminal and the second terminal according to the start request information;
a second acquiring unit configured to obtain participation request information for requesting participation of a third terminal in the session, and the participation authentication information input from the third terminal; and
a participation determination unit configured to, when the participation request information consists of a participation request in the session in which the participation of the terminal is limited, compere the participation authentication obtained by the first acquiring unit and participation authentication information obtained by the second acquiring unit, and determine whether participation of the third terminal in the session is allowed or not according to a result of comparison, and the participation determination unit configured, if the participation of the third terminal in the session is not allowed, to record terminal information of the third terminal, and to reject a subsequent participation request of the third terminal in the session thereafter on the basis of the recorded terminal information,
the method comprising:
obtaining start request information for requesting start of the session between the first terminal and the second terminal and the start request information including information for specifying whether participation in the session of a terminal other than the first terminal and the second terminal is limited or not, and the participation authentication information for authenticating participation in the session for the terminal when the participation of the terminal in the session is limited;
establishing the session between the first terminal and the second terminal according to the start request information;
obtaining the participation request information for requesting participation of the third terminal in the session, and the participation authentication information input from the third terminal;
when the participation request information consists of the participation request in the session in which the participation of the terminal is limited, compering the participation authentication obtained by the first acquiring unit and the participation authentication information obtained by the second acquiring unit, and determining whether participation of the third terminal in the session is allowed or not according to the result of comparison, and if the participation of the third terminal in the session is not allowed, recording the terminal information of the third terminal, and rejecting the subsequent participation request of the third terminal in the session thereafter on the basis of the recorded terminal information.

9. A computer readable medium including a computer program product, the computer program product comprising instructions which, when executed by a computer, causes the computer to perform operation of a communication system, the communication system comprising:
a first acquiring unit configured to obtain start request information for requesting start of a session between a first terminal and a second terminal and the start request information including information for specifying whether participation in the session of a terminal other than the first terminal and the second terminal is limited or not, and participation authentication information for authenticating participation in the session for the terminal when the participation of the terminal in the session is limited;
a session manager configured to establish the session between the first terminal and the second terminal according to the start request information;
a second acquiring unit configured to obtain participation request information for requesting participation of a third terminal in the session, and the participation authentication information input from the third terminal; and
a participation determination unit configured to, when the participation request information consists of a participation request in the session in which the participation of the terminal is limited, compere the participation authentication obtained by the first acquiring unit and participation authentication information obtained by the second acquiring unit, and determine whether participation of the third terminal in the session is allowed or not according to a result of comparison, and the participation determination unit configured, if the participation of the third terminal in the session is not allowed, to record terminal information of the third terminal, and to reject a subsequent participation request of the third terminal in the session thereafter on the basis of the recorded terminal information,
the operation comprising:
obtaining start request information for requesting start of the session between the first terminal and the second terminal and the start request information including information for specifying whether participation in the session of a terminal other than the first terminal and the second terminal is limited or not, and the participation authentication information for authenticating participation in the session for the terminal when the participation of the terminal in the session is limited;
establishing the session between the first terminal and the second terminal according to the start request information;
obtaining the participation request information for requesting participation of the third terminal in the session, and the participation authentication information input from the third terminal;
when the participation request information consists of the participation request in the session in which the participation of the terminal is limited, compering the participation authentication obtained by the first acquiring unit and the participation authentication information obtained by the second acquiring unit, and determining whether participation of the third terminal in the session is allowed or not according to the result of comparison, and if the participation of the third terminal in the session is not allowed, recording the terminal information of the third terminal, and rejecting the subsequent participation request of the third terminal in the session thereafter on the basis of the recorded terminal information.
